(19) United States
(12) Patent Application Publication
(10) Pub. No.: US 2025/0348079 A1
(43) Pub. Date: Nov. 13, 2025

(54) MOBILE ROBOT AND ITS OPERATION METHOD

(71) Applicant: LG ELECTRONICS INC., Seoul (KR)

(72) Inventor: Mihyun PARK, Seoul (KR)

(73) Assignee: LG ELECTRONICS INC., Seoul (KR)

(21) Appl. No.: 18/936,122

(22) Filed: Nov. 4, 2024

(30) Foreign Application Priority Data
May 9, 2024 (KR) 10-2024-0061378

(51) Int. Cl. G05D 1/622

(52) U.S. Cl. CPC G05D 1/637

(57) ABSTRACT

A mobile robot can include a projector configured to project visual information onto one or more surfaces, and a controller configured to project, via the projector, first visual information for marking a safety area onto a ground surface in a vicinity of the mobile robot while the mobile robot is traveling, and in response to determining a change in at least one of a traveling state of the mobile robot or a surrounding situation of the mobile robot, generate changed first visual information and project the changed first visual information onto the ground surface.

### CROSS-REFERENCE TO RELATED APPLICATION

Pursuant to 35 U.S.C. § 119(a), this application claims the benefit of the earlier filing date and the right of priority to Korean Patent Application No. 10-2024-0061378, filed in the Republic of Korea, on May 9, 2024, the entirety of which is incorporated by reference herein into the present application.

### BACKGROUND

### Field

The present disclosure relates to a mobile robot and an operational method of the mobile robot and, more particularly, to a mobile robot, capable of projecting visual information for a safety area while the mobile robot travels, and an operational method of the mobile robot.

### Description of the Related Art

In recent years, mobile robots have been utilized for various purposes. Therefore, in addition to a display, a projector has been mounted on the mobile robot as needed to provide various functions.

Usually, the use of the projector mounted on the mobile robot is limited to providing image display for entertainment.

It is disclosed in Korean Patent Application Publication No. 10-2019-0171901 (hereinafter referred to as ‘Related Document 1’) that a robot equipped with a projector selects a projection area based on image information and user information. However, Related Document 1 does not extensively provide visual information associated with the safety of a robot.

In addition, a technology for displaying a safety guide and information is only partially disclosed in Korean Patent Application Publication No. 10-2016-0162063 (hereinafter referred to as ‘Related Document 2’). However, this technology provides only the safety guide in the designated form and does not reflect various states or surrounding situations of a mobile robot. Consequently, the mobile robot does not perform a satisfactory function for ensuring travel safety.

Thus, a need exists for a mobile robot that is capable of projecting visual information for marking a safety area to prevent safety accidents, such as collisions, and capable of addressing changing conditions.

### SUMMARY OF THE DISCLOSURE

One object of the present disclosure is to provide a mobile robot that includes a projector on the body and is capable of projecting visual information for marking a safety area to prevent safety accidents, such as collisions, while traveling, and an operational method of the mobile robot.

Another object of the present disclosure is to provide a mobile robot capable of providing travel safety by externally marking a safety area suitable for a current travel state of the mobile robot using a projector included in the mobile robot, and an operational method of the mobile robot.

Yet another object of the present disclosure is to provide a mobile robot capable of externally marking an expected operation of itself, even if an obstacle or a person in the vicinity of the mobile robot moves in an unpredicted direction, thereby avoiding a collision, and an operational method of the mobile robot.

Another object of the present disclosure is to provide a mobile robot capable of marking a position of the mobile robot having a different travel state than an external mobile robot, even if mutual communication among a plurality of mobile robots is difficult or communication with the mobile robot is in an unstable state, and an operational method of the mobile robot.

Still another object of the present disclosure is to provide a mobile robot capable of externally marking a safety area in such a manner that a change in an operational state of the mobile robot, such as the use of the mobile robot with a cart connected thereto, is immediately perceived even from in front of the mobile robot, and an operational method of the mobile robot.

Still another object of the present disclosure is to provide a mobile robot capable of externally marking a risk area for safety through a projector in a situation where the risk area is encountered while the mobile robot travels through a designated travel space, and an operational method of the mobile robot.

Still another object of the present disclosure is to provide a mobile robot capable of externally marking a safety area associated with traveling through a projector provided on one side thereof while traveling.

Still another object of the present disclosure is to provide a mobile robot capable of sensing a change in a travel stare or a surrounding situation of the mobile robot and then externally projecting a marking of a safety area.

According to one aspect of the present disclosure, there is provided a mobile robot including a projector provided on one side of the mobile robot in such a manner as to project visual information; and a control unit configured to control the projector in such a manner as to externally project the visual information. In the mobile robot, the control unit controls the projector in such a manner that first visual information for marking a safety area is projected onto the ground in the vicinity of the mobile robot while the mobile robot travels, determines, based on at least one change in a travel state or a surrounding situation of the mobile robot, that the safety area is changed, and controls the projector in such a manner that the first visual information is changed according to the determination and that the changed first visual information is projected.

In the mobile robot, the safety area can be an area outside an access restriction area determined based on a form and the travel state of the mobile robot, and the first visual information can be at least one of the following: an image or text that indicates the access restriction area in such a manner that a border between the safety area and the access restriction area is visually distinguished.

The mobile robot can further include a sensing unit configured to sense a travel speed of the mobile robot, in which the control unit can perceive the sensed travel speed as a change in the travel state of the mobile robot, determine a change in the safety area, and control the projector in such a manner that at least one of the following: a color or a size of the first visual information is changed according to the determination.

In the mobile robot, the sensing unit can sense a travel direction of the mobile robot, and the control unit can control the projector in such a manner that an image shape of the first visual information is elongated toward the sensed travel direction.

In the mobile robot, an image size of the first visual information can increase or decrease in correspondence with the sensed travel speed, and an image color of the first visual information can change in such a manner that a warning level varies in correspondence with the sensed travel speed.

The mobile robot can further include a sensing unit configured to sense an obstacle in the vicinity of the mobile robot, in which the control unit can control the projector, based on the sensed obstacle approaching the mobile robot, in such a manner that the first visual information varies according to a state of the sensed obstacle.

In the mobile robot, the travel state can include an operational state that varies depending on whether another moving body is connected, in which the control unit can sense the moving body connected to a connection member of the mobile robot, and control the projector, based on information on the moving body, in such a manner that the first visual information is changed and that the changed first visual information is projected.

In the mobile robot, the information on the moving body can include information on the number of moving bodies connected to the mobile robot. In addition, in the mobile robot, the control unit can control the projector, based on the information on the number of connected moving bodies, in such a manner that at least one of the following varies: a size or a shape of the first visual information.

In the mobile robot, the control unit can control the projector, based on the information on the number of connected moving bodies, in such a manner that at least one change in a size or a shape of the first visual information appears in correspondence with a travel direction of the mobile robot.

In the mobile robot, the information on the moving body can include information on an amount of load present on the moving body connected to the mobile robot. In addition, in the mobile robot, the control unit can estimate an access restriction area based on the information on the amount of load present on the moving body, and control the projector in such a manner as to change at least one of the following according to the estimated access restriction area: a size or a shape of the first visual information.

The mobile robot can further include a sensing unit configured to sense a surrounding situation of the mobile robot at a position of the mobile robot. In addition, in the mobile robot, the control unit can perceive a crossway or a corner due to a change in the surrounding situation of the mobile robot and control the projector, based on the mobile robot approaching the crossway or the corner, in such a manner as to change at least one of the following: a shape or a size of the first visual information.

In the mobile robot, the control unit can adjust, in correspondence with the extent to which the mobile robot approaches the crossway or the corner, the extent to which at least one of the following is changed: the shape or the size of the first visual information. In addition, in the mobile robot, when it is sensed that the mobile robot has passed through the crossway or the corner, the mobile robot can control the processor in such a manner that the shape or the size of the first visual information is restored to the previous state thereof.

In the mobile robot, the control unit can project the first visual information onto the ground before the mobile robot starts to travel, and, based on a predetermined time having elapsed after the mobile robot stopped traveling, interrupt the projection of the first visual information.

According to another aspect of the present disclosure, there is provided a mobile robot including: a projector provided on one side of the mobile robot in such a manner as to project visual information; and a control unit configured to control the projector in such a manner as to externally project the visual information. In addition, in the mobile robot, the control unit controls the projector in such a manner that first visual information for marking a safety area is projected onto the ground in the vicinity of the mobile robot while the mobile robot travels, determine the next operation of the mobile robot based on at least one change in a travel state or a surrounding situation of the mobile robot, and control the projector in such a manner that a second visual information associated with the scheduled next operation is projected according to the determination.

The mobile robot can further include a sensing unit configured to sense an obstacle in the vicinity of the mobile robot, in which the control unit can determine the next operation of the mobile robot based on the obstacle approaching the mobile robot due to a change in the surrounding situation and control the projector in such a manner that the second visual information indicating the sensing of the obstacle is projected according to the determination before the scheduled next operation is performed.

In the mobile robot, as the next operation, the control unit can determine to travel around the obstacle and control the projector in such a manner that the second visual information indicating a position of the obstacle is projected according to the determination before the mobile travels around the obstacle.

In the mobile robot, in a situation where the mobile robot is unable to travel around the obstacle due to a travel state of the mobile robot, in order to allow the sensed obstacle to move around the mobile robot, the control unit can control the projector in such a manner that a third visual information indicating access restriction is projected onto the ground in the vicinity of the mobile robot.

The mobile robot can further include a sensing unit configured to sense an obstacle in the vicinity of the mobile robot. In addition, in the mobile robot, as the next operation of the mobile robot, the control unit can determine to provide a mobile guide for a first obstacle, based on the sensing of a plurality of obstacles due to a change in the surrounding situation, and control the projector in such a manner that the second visual information indicating the mobile guide based on positions of the mobile robot and the second obstacle, is projected according to the determination.

In the mobile robot, the second visual information can include a first mobile guide for marking a safety area, which is based on the positions of the mobile robot and the second obstacles, and a second mobile guide for marking a risk area, which is based on the positions of the mobile robot and the second obstacles, the second mobile guide being distinguished from the first mobile guide.

The mobile robot can further include a sensing unit configured to sense a state of the ground while the mobile robot travels. In addition, in the mobile robot, the control unit can detect a risk area based on the sensed state of the ground and control the projector in such a manner that the second visual information indicating the detected risk area is marked before the mobile robot comes to a stop as the next operation thereof.

With the mobile robot and the operational method of the mobile robot according to an embodiment of the present disclosure, while traveling, the mobile robot marks the safety area through the projector. Furthermore, while traveling, the mobile robot adaptively varies the safety area according to the travel state and the surrounding situation of the mobile robot. Consequently, the travel safety can be ensured more reliably, and can be recognized quickly from the outside.

In addition, the visual information for ensuring the travel safety can be projected in various forms. The visual information to be projected can be flexibly varied in such a manner as to reflect the safety area that is changed according to the travel state and the surrounding situation of the mobile robot.

In addition, mutual recognition is possible without direct communication between the mobile robot and another robot in the vicinity thereof, allowing them to recognize each other's next operations for the travel safety. Accordingly, the mobile robot can effectively deal with the robot to prevent a collision or a similar accident, and a manager can visually anticipate the next operation of the mobile robot.

In accordance with the purpose of using the mobile robot, the mobile robot is used with another moving body being connected to the rear thereof. In this situation, pieces of information such as the presence of the moving body, the number of connected moving bodies, and loads present on the moving bodies are included in the visual image for the safety area, which is projected onto the ground in front of the mobile robot. Additionally, a safety distance is in the visual image and is marked. Thus, an external robot or a person can pass around not only the mobile robot that travels, but also the entire mobile robot that includes various carts connected to the rear thereof.

In addition, a caution section and a risk section that the mobile robot senses while traveling can be externally marked in such a manner that a robot or a person in the vicinity of the mobile robot can perceive these sections, thereby aiding in securing the travel safety of the robot or the safety of the person.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram illustrating an example configuration of a mobile robot according to an embodiment of the present disclosure;

FIG. 2 is a representative flowchart that is referenced to describe an operational method of a mobile robot according to an embodiment of the present disclosure;

FIGS. 3A to 3C are views illustrating various examples, respectively, where the mobile robot according to an embodiment of the present disclosure externally marks a traveling-associated safety area;

Parts (a), (b) and (c) of FIG. 4 are example views, respectively, that are referenced to describe a method of marking the safety area in a manner that varies with a travel speed of the mobile robot according to an embodiment of the present disclosure;

Parts (a) and (b) of FIG. 5 and part (a) and (b) of FIG. 6 are example views, respectively, that are referenced to describe a method in which the mobile robot according to an embodiment of the present disclosure marks the safety area in a manner that varies according to a travel direction;

FIG. 7 is an example view that is referenced to describe how the safety area is marked in a varied manner when an obstacle approaches the mobile robot according to an embodiment of the present disclosure;

FIGS. 8A and 8B are example views, respectively, that are referenced to describe a change in the marking of the safety area, which varies with a change in the form of the mobile robot according to an embodiment of the present disclosure;

FIGS. 8C and 8D are example views, respectively, that are referenced to describe a

change in the marking of the safety area based on information on an amount of load present on another moving body connected to the mobile robot according to an embodiment of the present disclosure;

FIG. 9 is an example view that is referenced to describe how the safety area is marked in a varied manner when the mobile robot according to an embodiment of the present disclosure travels along a corner;

FIG. 10 is a flowchart that is referenced to describe another operational method of the mobile robot according to an embodiment of the present disclosure;

FIGS. 11A and 11B are example views each illustrating that the mobile robot according to an embodiment of the present disclosure marks the intention thereof to perform a travel-around operation, along with the safety area for itself, in response to an approaching obstacle;

FIG. 12 is an example view illustrating that, while traveling, the mobile robot marks the inability thereof to perform the travel-around operation, along with the safety area for itself, in response to an approaching obstacle according to an embodiment of the present disclosure;

FIGS. 13A, 13B, and 13C are views, respectively, that are referenced to describe an example where, when the mobile robot according to an embodiment of the present disclosure senses a plurality of obstacles, the mobile robot marks the safety area by considering expected movements of the obstacles; and

FIGS. 14A, 14B, and 14C are views, respectively, that are referenced to mark a risk area sensed while the mobile robot according to an embodiment of the present disclosure travels.

### DETAILED DESCRIPTION OF THE EMBODIMENTS

Description will now be given in detail according to example embodiments disclosed herein, with reference to the accompanying drawings. For the sake of brief description with reference to the drawings, the same or equivalent components can be provided with the same or similar reference numbers, and description thereof will not be repeated. In general, a suffix such as “module” and “unit” can be used to refer to elements or components. Use of such a suffix herein is merely intended to facilitate description of the specification, and the suffix itself is not intended to give any special meaning or function. In describing the present disclosure, if a detailed explanation for a related known technology or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. can be used herein to describe various elements, these elements should not be limited by these terms. These terms are generally only used to distinguish one element from another.

It will be understood that when an element is referred to as being “connected with” another element, the element can be connected with the another element or intervening elements can also be present. In contrast, when an element is referred to as being “directly connected with” another element, there are no intervening elements present.

A singular representation can include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps can likewise be utilized.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

A ‘mobile robot’ disclosed in the present specification can perform autonomous traveling by itself and refers to a machine that operates to execute an assigned task. Mobile robots can be categorized by their usage purpose and application into those for industry, home, military, and medical treatment.

Tasks assigned to the mobile robot can include cleaning, delivery, serving, product arrangement, guiding, content provision, and the like. The mobile robot can perform various functions, operations, and the like to execute the assigned task. In addition, the mobile robot includes a drive unit that has an actuator, a motor, a brake, and the like, to perform an operation for autonomous traveling.

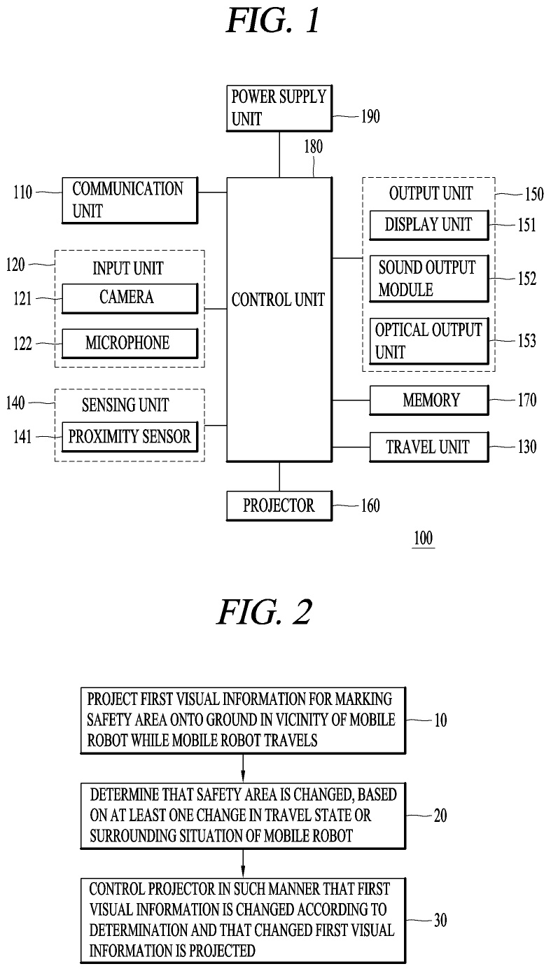

FIG. 1 is a block diagram illustrating an example configuration of a mobile robot 100 according to the present disclosure.

With reference to FIG. 1, the mobile robot 100 according to an embodiment of the present disclosure can include a communication unit 110 (e.g., communication interface or transceiver), an input unit 120 (e.g., input interface), a travel unit 130 (e.g., a driver or a motor), a sensing unit 140 (e.g., one or more sensors), an output unit 150, a projector 160, memory 170, a control unit 180 (e.g., a controller or a processor), and a power supply unit 190 (e.g., a power supply). Constituent elements illustrated in FIG. 1 are not all indispensable in implementing the mobile robot 100. The mobile robot 100 can include one or more constituent elements in addition to the above-mentioned constituent elements or can omit one or more constituent elements from among the above-mentioned constituent elements.

The communication unit 110 (e.g., communication interface or transceiver) can include at least one module for enabling wireless communication between the mobile robot 100 and an external server, for example, an artificial intelligence server or an external terminal. In addition, the communication unit 110 can include one or more modules through which the mobile robot 100 is connected to one or more networks. In addition, the communication unit 110 can include one or more modules through which the mobile robot 100 can communicate with other robots.

The communication unit 110 can perform communications with an artificial intelligence (AI) server and other similar servers by using wireless Internet communication technologies, such as Wireless LAN (WLAN), Wireless Fidelity (Wi-Fi), Wi-Fi Direct, Digital Living Network Alliance (DLNA), Wireless Broadband (WiBro), World Interoperability for Microwave Access (WiMAX), High SpeedDownlink Packet Access (HSDPA), High Speed Uplink Packet Access (HSUPA), Long Term Evolution (LTE), and Long Term Evolution-Advanced (LTE-A). The communication unit 110 can also perform communications with an external terminal and other similar terminals by using short-range communication technologies, such as BLUETOOTH™, Radio Frequency Identification (RFID), Infrared Data Association (IrDA), Ultra Wideband (UWB), ZIGBEE, and Near Field Communication (NFC).

The input unit 120 (e.g., input interface) can include a camera 121 or an image input unit for inputting an image signal, a sound reception module 122, for example, a microphone, for inputting an audio signal, and a user input unit (e.g., a touch key, a mechanical key, or the like) for receiving information, as input, from a user. Signal data, voice data, and image data, which are collected by the input unit 120, can be analyzed and processed as control commands.

The camera 121 can be provided on one side of the main body of the mobile robot 100 or at a plurality of positions on the main body. In the latter situation, one camera can be provided on a front surface of the main body in such a manner as to face forward, and another camera can be provided on a side or rear surface of the main body in such a manner as to face sideways/backward. Accordingly, an angle of view covering 360 degrees can be formed.

When a plurality of cameras 121 are provided, a first camera can, for example, be a 3D stereo camera. The 3D stereo camera can perform functions such as obstacle sensing, recognition of a user's face, and stereoscopic image acquisition. Through the use of the first camera, the mobile robot 100 can sense and avoid an obstacle existing in the moving direction of itself and can perform various control operations by recognizing a user. In addition, the second camera can, for example, be a Simultaneous Localization And Mapping (SLAM) camera. The SLAM camera performs a function of tracking the current position of the camera through feature point matching and creating a 3D map based on the tracking result. The mobile robot 100 can ascertain a current position of itself using the second camera. In addition, the camera 121 can recognize an object in a viewing angle range and perform a function of capturing a still image and a moving image of the object. In relation to this, the camera 121 can include at least one of the following sensors: a camera sensor (e.g., a CCD sensor or a CMOS sensor, among other sensors), a photo sensor (or image sensor), or a laser sensor. The camera 121 and the laser sensor can be combined to sense a touch of a sensing target on a 3D stereoscopic image. The photo sensor can be stacked on a display element, and be configured to scan the motion of the sensed target that approaches a touch screen. More specifically, the photo sensor includes photodiodes and transistors (TRs) mounted in rows/columns, and thus scans an object placed on the photo sensor using an electric signal that changes according to an amount of light applied to the photo diodes. That is, the photo sensor can perform calculation of coordinates of the sensing target that vary according to a change in the amount of light, and can acquire positional information of the sensing target based on the coordinates.

The travel unit 130 (e.g., driver or motor) performs movement and rotation of the main body of the mobile robot 100. To this end, the travel unit 130 can include a plurality of wheels and driving motors. The operation of the travel unit 130 can be controlled according to a control command received by the control unit 180, and a notification can be provided through an optical output unit 153 such as an LED before and after the travel unit 130 is operated.

The sensing unit 140 can include one or more sensors for sensing at least one of the following information: internal information of the mobile robot, the surrounding environment of the mobile robot, or user information. For example, the sensing unit 140 can include at least one of the following sensors: a proximity sensor 141, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., the camera 121), a microphone, a battery gauge, an environment sensor (e.g., a barometer, a hygrometer, a thermometer, a radiation sensor, a thermal sensor, or a gas sensor, among others), or a chemical sensor (e.g., an electronic nose, a health care sensor, or a biometric sensor, among other sensors).

The mobile robot 100 disclosed in the present specification can utilize, in combination, information obtained from at least two sensors of these sensors.

In addition, the sensing unit 140 can include a travel-related sensor that senses an obstacle, a state of the ground, and the like.

In addition, an illumination sensor of the sensing unit 140 can be used to determine an image size of visual information to be projected through the projector 160 described below.

Examples of the proximity sensor 141 can include a transmission type photoelectric sensor, a direct reflection type photoelectric sensor, a mirror reflection type photoelectric sensor, a high frequency oscillation type proximity sensor, a capacitive proximity type sensor, a magnetic type proximity sensor, and an infrared proximity sensor, among other sensors.

In addition, the proximity sensor 141 can include at least one of the following: a navigator camera, an ultrasonic sensor, a Lidar, or a ToF sensor, and can recognize the approach and position of the sensing target (e.g., the user) through this device.

The output unit 150 can serve to generate an output related to visual information, auditory information, tactile information, or the like and can include at least one of the following: a touch screen 151, a sound output unit 152, or an optical output unit 153. The touch screen 151 can be interlayered with or integrally formed with a touch sensor to realize a touch screen. The touch screen can function as a user input unit for providing an input interface between the mobile robot 100 and the user and simultaneously provide an output interface between the mobile robot 100 and the user.

The sound output module 152 can perform a function of notifying the user of information in the form of voice, and can, for example, be in the form of a speaker. Specifically, a response or search result corresponding to the user's voice, which is received through the microphone 122 and a voice recognition unit provided on the mobile robot 100, is output in the form of voice through the sound output module 152.

In addition, the sound output module 152 can output voice information related to a screen (e.g., a menu screen or an advertisement screen, among other screens) displayed on the touch screen 151. To this end, the microphone 122 can perform a function of receiving the user's voice and the like. In addition, the microphone 122 can process an external sound signal into electrical voice data, and implement various noise removal algorithms for removing noise generated in the course of receiving the external sound signal.

In addition, the sound output module 152 can output a sound signal that matches visual information that is projected through the projector 160.

The optical output module 153 outputs a signal for providing a notification indicating that an event has occurred to the mobile robot 100, using light from a light source. For example, when a movement command is transferred to the travel unit 130 of the mobile robot 100, a signal for providing notification indicating a movement is output through the optical output module 153.

The projector 160 can be provided on one side of the main body of the mobile robot 100 or at a plurality of positions on the main body. Specifically, in a situation where the projector 160 is positioned on an upper portion of the mobile robot 100, the projector 160 can be positioned above the travel unit 130. In addition, in a situation where the projector 160 is positioned on a lower portion of the mobile robot 100, the projector 160 can be positioned on one side of the head of the mobile robot 100. In addition, the projector 160 can be provided at a plurality of positions on the main body of the mobile robot 100.

The projector 160 can be realized in such a manner as to rotate, move, or tilt in correspondence with the body of the mobile robot 100 when the body thereof rotates, moves, or tilts. As another example, the projector 160 can be formed in such a manner as to rotate and/or tilt by independently to adjust a projection angle. As still another example, the projector 160 can be a mobile projector formed in such a manner as to enable projection on various projection areas.

The projector 160 projects visual information onto the ground in the vicinity of the mobile robot 100. In one practical example, the projector 160 can project visual information onto a designated projection area. For example, while the mobile robot 100 stops or travels, the projector 160 can project visual information onto at least one of the following: the ground, a ceiling, or a wall surface. Also, according to an embodiment, the projector 160 can project visual information onto parts of the mobile robot 100 itself.

In an embodiment of the present disclosure, the projector 160 can project visual information indicating a safety guide while the mobile robot 100 travels. In addition, the projector 160 can sense a travel state and/or a surrounding situation of the mobile robot 100 and project the safety guide accordingly.

The control unit 180 controls the overall operation of the mobile robot 100 and performs computation and data processing. In addition, the term ‘control unit 180’ can be considered synonymous with ‘processor’ or ‘controller’ or be understood as a module that includes the processor. The processor can include at least one of the following: a central processing unit or an application/communication processor.

In addition, the control unit 180 (e.g., controller) can determine the visual information to be projected through the projector 160 and control the overall operation of the projector 160, such as rotation, movement, and tilting, for projection angle adjustment.

In addition, the control unit 180 (e.g., controller) can control the travel unit 130 to move or rotate the mobile robot 100. In addition, the control unit 180 can include a learning data unit to perform an operation associated with the artificial intelligence technology of the mobile robot 100. The learning data unit can be configured to receive, classify, store, and output information to be used for data mining, data analysis, intelligent decision making, a machine learning algorithm, and a machine learning technology. The learning data unit can include at least one memory unit configured to store information, which is received, detected, sensed, generated, or predefined through the mobile robot 100 or information output through the mobile robot in a different way, or to store data, which are received, detected, sensed, generated, predefined or output through another component, device, and terminal.

In one practical example, the learning data unit can be integrated with the mobile robot 100 or can have the memory thereof. In one practical example, the learning data unit can be realized through the memory 170. However, the learning data unit is not limited to this. Alternatively, the learning data unit can be implemented in external memory associated with the mobile robot 100, or can be realized through memory included in a server that is communicable with the mobile robot 100. In another practical example, the learning data unit can be realized through memory which is maintained in a cloud computing environment, or through remotely controllable memory, different from this memory, which is accessible by the mobile robot 100 through communication methods such as a network.

The learning data unit is typically configured to store data, which are used for supervised or unsupervised learning, data mining, prediction analysis, or a different machine learning technology, in one or more databases for the purpose of identification, indexation, classification, manipulation, storage, search, and output. Information stored in the learning data unit can be used by the control unit 180, which uses at least one of the following different types: the data analysis, the machine learning algorithm, or the machine learning technology. Alternatively, this information can be used by a plurality of control units (processors) included in the mobile robot 100.

The control unit 180 (e.g., controller) can determine or predict an executable operation of the mobile robot based on information determined or generated using the data analysis, the machine learning algorithm, and the machine learning technology. To this end, the control unit 180 can request, search for, receive, or utilize data from a learning data unit. The control unit 180 can perform various functions of realizing a knowledge-based system, an inference system, a knowledge acquisition system, and the like, and can perform various functions for a system (e.g., a fuzzy logic system) for uncertain inference, an adaptation system, a machine learning system, an artificial neural system, an artificial neural network and the like.

The control unit 180 can also include sub-modules, such as an I/O processing module, an environmental condition module, a speech-to-text (STT) processing module, a natural language processing module, a task flow processing module, and a service processing module, which enable voice and natural language processing. Each of the sub-modules can have the authority to access one or more systems, data, models, or their subsets or supersets in the mobile robot 100. At this point, objects that each of the sub-modules has the authority to access can include scheduling, a vocabulary index, user data, a task flow model, a service model, and an automatic speech recognition (ASR) system.

In one or several practical examples, the control unit 180 (e.g., controller) can also be configured to detect and sense the user's requirements based on a contextual condition or the user's intent that is represented by the user's input or natural language input based on the data in the learning data unit. When the operation of the mobile robot 100 is determined based on the data analysis, the machine learning algorithm, and the machine learning technology, which are performed by the learning data unit, the control unit 180 can control constituent elements of the mobile robot 100 to perform the determined operation. The control unit 180 can perform the determined operation by controlling the mobile robot, based on a control command.

Data supporting various functions of the mobile robot 100 are stored in the memory 170. For example, a multiplicity of application programs (or applications), which are executed in the mobile robot 100, and data or commands for operating the mobile robot 100 can be stored in the memory 170. In addition, a variable call word for performing a function of a voice conversation with the user can be stored in the memory 170.

The memory 170, for example, can include at least one of the following types of storage media: flash memory, hard disk memory, solid-state disk (SSD) memory, silicon disk drive (SDD) memory, multimedia card micro memory, card type memory (for example, SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, or optical disk.

For example, visual information to be projected through the projector 160 can be stored in the memory 170.

The control unit 180 (e.g., controller) typically functions to control the overall operation of the mobile robot 100, in addition to an operation associated with the application program. The control unit 180 can provide appropriate information or an appropriate function to the user or process this information or function by processing a signal, data, information, and the like that are input or output through the above-mentioned constituent elements, by executing the application program stored in the memory 170, or by controlling the travel unit 130.

Under the control of the control unit 180, the power supply unit 190 receives external power or internal power and supplies it to each of the constituent elements included in the mobile robot 100. The power supply unit 190 can include a battery. The battery can be an internal battery or a replaceable battery.

At least some of the constituent elements can cooperatively operate to realize operations, controls, or control methods of the mobile robot 100 according to various practical examples described below. In addition, the operations, controls, or control methods of the mobile robot 100 can be realized on the mobile robot 100 by executing at least one application program stored in the memory 170.

In addition, various practical examples described below can be realized in a medium readable by a computer or similar device using, for example, software, hardware, or a combination of both.

Various practical examples associated with a method in which the mobile robot 100 according to the embodiment of the present disclosure marks a safety area for travel safety using the projector 160 are described below with the accompanying drawings.

FIG. 2 is a representative flowchart that is referenced to describe an operational method of the mobile robot 100 according to an embodiment of the present disclosure.

The operational method of the mobile robot 100, which is illustrated in FIG. 2, also applies to a situation where the mobile robot 100 remains stationary after stopping during traveling. In addition, unless otherwise specified, the operational method of the mobile robot 100, which is illustrated in FIG. 2, can be performed by the control unit 180 (or a processor, or a controller) of the mobile robot 100. In addition, each step of the flowchart in FIG. 2 can be realized by a program command that is executed by at least one processor.

With reference to FIG. 2, while the mobile robot 100 is traveling, the mobile robot 100 can project the first visual information for marking the safety area onto the ground in the vicinity of the mobile robot 100 (e.g., step 10).

At this point, the expression ‘while the mobile robot 100 travels’ refers to both the duration during which the mobile robot 100 travels within a travel space and the situation where the mobile robot 100 remains stationary after stopping during traveling. Therefore, once the mobile robot 100 starts a travel operation, the mobile robot 100 can externally project the first visual information for marking the safety area through the projector 160.

In addition, the first visual information serves as visual information for marking the safety area for the mobile robot 100 and can include text and/or an image, videos or animations. The text here can include a symbol, a letter, a number, a mark, and the like. The image here can include a dot, a line, a specific image, and a moving image. In addition, in practical examples described below, the first visual information can be described as being transformed into a first visual image, a visual image for marking the safety area, a visual image for marking an access restriction area, and other images.

In addition, projecting onto the ground in the vicinity of the mobile robot 100 can refer to projecting in the form of a beam onto the ground in the vicinity of the mobile robot 100 at the current position thereof, or projecting onto the wall surface or the ceiling instead of the ground in a situation where a predetermined condition is satisfied.

According to a practical example, the safety area can refer to an access restriction area in the vicinity of the mobile robot 100, which is determined based on the form of the mobile robot 100 and the travel state thereof. The access restriction area here can refer to a protection area for preventing the mobile robot 100 from colliding with an external object or refer to the surrounding area of the mobile robot 100. In this situation, the first visual information can be at least one of the following: an image or text that marks a border of the access restriction area in a manner that is visually distinguished from the surroundings of the mobile robot 100.

The mobile robot 100 can project the first visual information for marking the safety area.

In this situation, the first visual information can be an image in the form of a safety guide that alerts the surroundings of the mobile robots that access to the mobile robot 100 is restricted. That is, the first visual information serves as a line image for marking the access restriction area around the mobile robot 100, and can be an image for alerting a person or another moving body (e.g., another robot) that access inside the safety guide is restricted.

In addition, the first visual information can be an image in the form of a safety guide, which reflects a current travel state of the mobile robot 100. For example, the current travel state of the mobile robot 100 and a current travel direction thereof can be reflected in the first visual information, and the resulting first visual information can be projected.

In addition, the first visual information can be an image in the form of a safety guide, which reflects a current operational state of the mobile robot 100. For example, as in the situation where the mobile robot 100 is a product arrangement robot and is used with a cart being connected to the rear of the mobile robot 100, if the mobile robot 100 is used in a reconfigured state, this reconfigured state is reflected in the first visual information. Thus, when viewing only the front of the mobile robot 100, it can be intuitively recognized from the outside that the mobile robot 100 is used in the reconfigured state.

In addition, the first visual information can be an image in the form of a safety guide, which reflects the surrounding situation sensed by the mobile robot 100 through the sensing unit 140. For example, in a situation where the ground slide, skidding, or slipping is sensed through a ground sensor of the mobile robot 100, this sensing result can be reflected in the first visual information, and the resulting first visual information can be projected. In addition, in a situation where the mobile robot 100 senses a moving body approaching through the proximity sensor 141, the mobile robot 100 can reflect the sensed moving body in the first visual information and then project the resulting first visual information. Thus, the mobile robot 100 can alert its surroundings that the moving object approaching is sensed and that the safety guide is marked.

When the mobile robot starts the travel operation and begins to move, the mobile robot 100 can activate the projector 160. In the activated state of the projector 160, the mobile robot 100 can project a visual image indicating the start of the travel operation. The mobile robot 100 can project the first visual information for externally marking the access restriction area onto the ground using one or more projectors 160 provided on the body thereof.

The control unit 180 (e.g., controller) of the mobile robot 100 can control the extent of rotation, movement, or tilting of the projector 160 to project the first visual information.

Next, after the first visual information is projected, the mobile robot 100 can determine that the safety area has been changed, based on at least one change in the travel state or the surrounding situation of the mobile robot 100 (e.g., step 20).

At this point, the expression ‘the safety area has been changed’ implies that the access restriction area around the mobile robot 100 is changed. For example, in a situation where at least one of the following is changed: a travel speed, a travel direction, or a travel technique of the mobile robot 100, or where one or more objects approach the mobile robot 100 or move away therefrom, the access restriction area around the mobile robot 100 can be adaptively expanded, reduced, or changed in form.

In addition, the expression ‘the safety area has been changed’ implies that the alert for restricting access to the mobile robot 100 is changed. For example, the expression ‘the safety area has been changed’ can imply that a short separation distance between a moving obstacle and the mobile robot 100 is sensed and that a determination is made to change the color, thickness, animation style, and highlighting of the safety guide (or the safety area) in the direction of raising an alert level in such a manner as to prevent a collision. In addition, for example, the expression ‘the safety area has been changed’ can imply that a short separation distance between a moving obstacle and the mobile robot 100 is sensed and that a determination is made to restore the alert level of the safety guide (or the safety area) to the original level thereof.

In addition, the expression ‘the safety area has been changed’ implies that a projection area for the visual information for marking the safety area for the mobile robot 100 is changed. At this point, the expression ‘the projection area is changed’ means that any one of the following is changed: the position or the size of the projection area. For example, the expression ‘the projection area is changed’ can imply that, according to the surrounding situation sensed through the sensing unit 140, it is determined that it is not appropriate for the mobile robot 100 to project the visual image onto the ground in the vicinity of the mobile robot 100.

According to the determination that the safety area is changed in this manner, the mobile robot 100 can control the projector 160 in such a manner that the first visual information is changed in correspondence with the change (e.g., step 30).

The mobile robot 100 can control the rotation, movement, or tilting of the projector 160 to change the first visual information according to the change in the safety area.

According to a practical example, the first visual information can be changed to reflect the travel state and the surrounding situation of the mobile robot 100 in real time.

In addition, according to a practical example, the mobile robot 100 can vary the visual information in such a manner to visually distinguish between the change in the safety area, which corresponds to the change in the travel state, and the change in the safety area, which corresponds to sensing a change in the surrounding situation. Accordingly, it can also be recognized from the outside whether the mobile robot 100 changes the travel state of itself or senses a change in the external situation.

According to a practical example, the mobile robot 100 can make a determination in such a manner as to perform the next operation for safety according to changes in the travel state and/or the surrounding situation. In this situation, the mobile robot 100 can control the operation of the projector 160 in such a manner that the next operation determined for safety is externally marked.

In this manner, according to the embodiment of the present disclosure, while traveling, the mobile robot 100 marks the safety area using the projector 160. Furthermore, while traveling, the mobile robot adaptively varies the safety area according to the travel state and the surrounding situation of the mobile robot 100. Consequently, the travel safety can be ensured in a more reliable manner and can be quickly recognized from the outside.

Various practical examples in which the mobile robot 100 according to the embodiment of the present disclosure ensures the travel safety using the projector 160 are described in detail below with reference to the drawings.

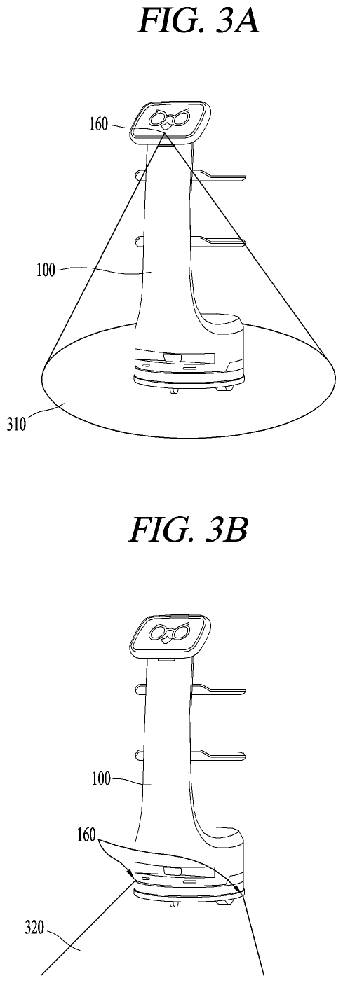

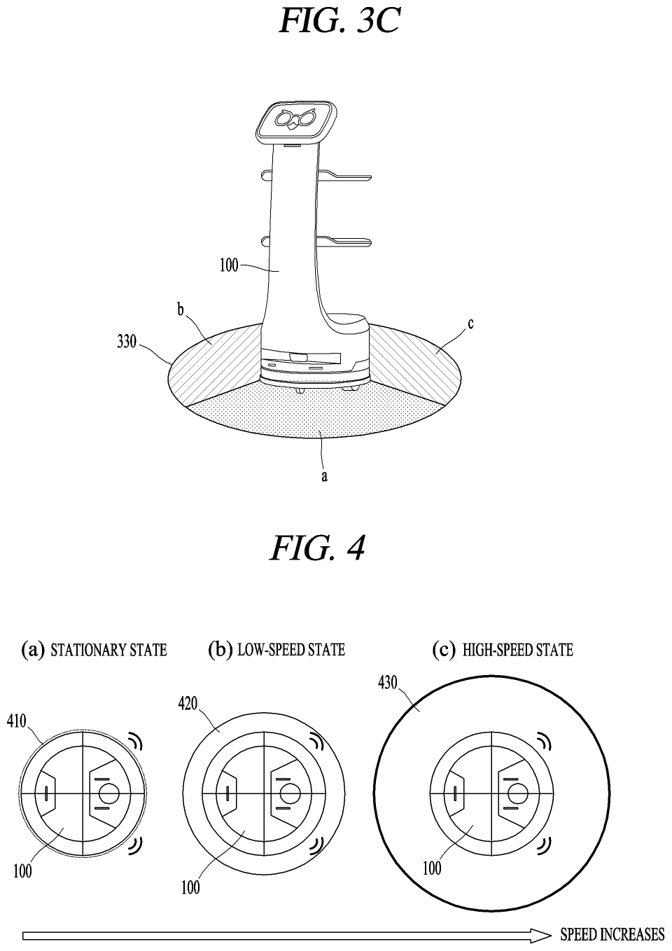

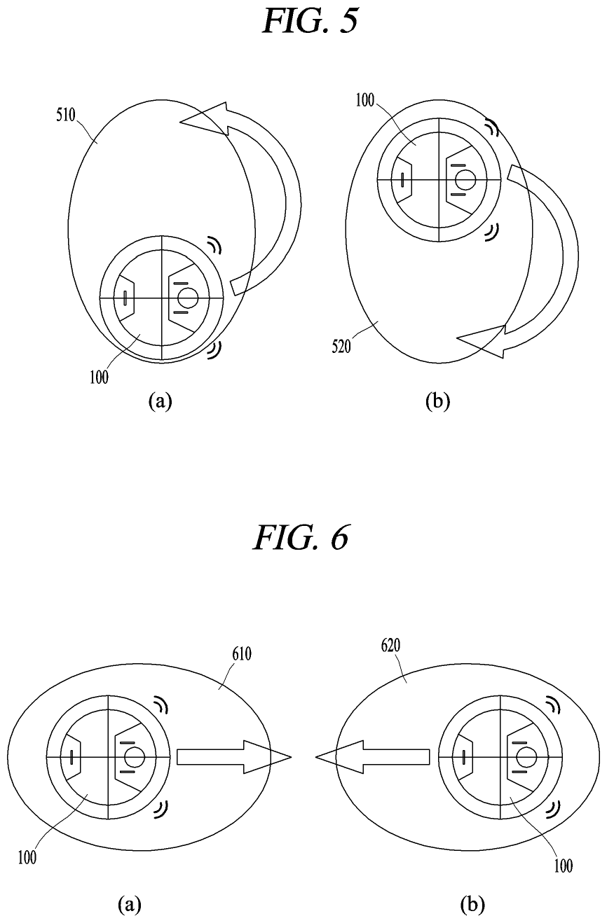

FIG. 3A to 3C are views illustrating various examples, respectively, where the mobile robot 100 according to embodiments of the present disclosure externally marks the traveling-associated safety area.

While traveling, the mobile robot 100 according to the present disclosure changes the visual information (e.g., ‘the first visual information’) for marking the safety area in a manner that adjusts according to the travel state of the mobile robot 100 and the sensed surrounding situation thereof and can project the changed visual information onto the ground in the vicinity of the mobile robot 100.

According to a practical example, the safety area can be the access restriction area determined based on the form and travel state of the mobile robot 100. The access restriction area constitutes a surrounding area of the mobile robot 100 and refers to an area or space where safety is ensured while the mobile robot 100 travels.

The mobile robot 100 externally marks the access restriction area in such a manner that a moving object (e.g., another robot or a person) in motion is prevented from accessing or entering the access restriction area. To this end, by controlling the projector 160, the mobile robot 100 can project at least one of the following as the first visual information: an image or text for marking the safety area in a manner that is visually distinguished from the surroundings of the mobile robot 100.

The size and the shape of the access restriction area can vary according to the form of the mobile robot 100. In addition, the size and the shape of the access restriction area can vary according to the travel speed and travel direction of the mobile robot 100. In addition, the size and the shape of the access restriction area can vary according to a change in the surrounding situation that is sensed by the mobile robot 100.

The first visual information can be an image for marking a border between the access restriction area and an area outside the access restriction area.

Specifically, the first visual information can be an image for marking only the border or be an image in which color is applied to the entire access restriction area. Alternatively, the first visual information can include text that accompanies or defines the border to be marked. However, these are just examples of the first visual information. Any image or text that allows the border of the access restriction area, indicating the safety area, to be intuitively recognized from the outside can sufficiently serve as the first visual information.

For example, FIGS. 3A and 3B are views each illustrating an example where the first visual information for marking the safety area for the mobile robot 100 is projected in the form of a guide line indicating the border of the access restriction area. In the illustrated guide line, an area that faces toward the center of the mobile robot 100 is the access restriction area.

FIG. 3A illustrated that the projector 160 constitutes the upper end portion of the mobile robot 100. The projector 160 of the mobile robot 100 illustrated in FIG. 3A can move, rotate, or tilt under the control of the control unit 180. Accordingly, a border guide line 310 for marking the safety area in the range of 360 degrees in the vicinity of the mobile robot 100 can be projected onto the ground.

As another practical example, a designated colored image can be projected onto an area inside the border guide line 310 illustrated in FIG. 3A. The designated colored image here can reflect an operating state the mobile robot 100 and the travel state thereof.

For example, before the mobile robot 100 starts to travel, the projector 100 can be activated, and a colored image in a designated pattern, which indicates that the safety area is markable, can be projected onto an area inside the guide line 310. For example, a colored image that matches the travel states, such as the travel speed and travel direction of the mobile robot 100, can be projected onto an area inside the guide line 310. For example, a colored image that matches a state, such as the remaining power of a battery in the mobile robot 100, can be projected onto an area inside the guide line 310. In this situation, not only can the travel safety of the mobile robot 100 be ensured, but information relating to the states of the mobile robot 100, such as the operating state and the travel state, can also be visually perceived.

FIG. 3B illustrates that the projector 160 constitutes the lower end portions of the mobile robot 100. Specifically, a safety guide 320 for marking the access restriction area can be projected through the projector 160, which constitutes the lower end portion of the mobile robot 100 in FIG. 3B and is provided, for example, on the upper end of the travel unit 130. The safety guide 320, as illustrated in FIG. 3B, can be a plurality of line images that are projected onto both sides, respectively, of the travel unit 130 in a manner that is elongated toward the scheduled travel direction of the mobile robot 100.

As another practical example, a gap between a plurality of line images included in the safety guide 320 can be determined after reflecting the operating state and the travel state of the mobile robot 100. For example, a gap between the line images can decrease or increase according to a current travel speed of the mobile robot 100.

In addition, as another practical example, the gap between the plurality of line images included in the safety guide 320 illustrated in FIG. 3B can vary as a result of reflecting information relating to the surrounding situation sensed by the mobile robot 100. For example, in a situation where a traveling area that matches the travel direction of the mobile robot 100 is sensed as an attention section or where an object approaches, the travel safety can be further ensured by increasing the gap between the plurality of line images.

FIG. 3C illustrates that a plurality of projectors 160 are positioned at the front and rear of the mobile robot 100. Also, the safety area 330 in the vicinity of the mobile robot 100 can be marked through different projectors 160 provided in such a manner as to indicate different risk levels.

For example, in the safety area 330 marked through the plurality of projectors 160, a front area (a) matching a front surface in the travel direction of the mobile robot 100 is marked in such a manner as to indicate a high risk level, and a lateral area (b) matching a lateral surface in the travel direction can be marked to indicate a medium risk level. In addition, a rear area (c) matching a rear surface in the travel direction of the mobile robot 100 can be marked in such a manner as to indicate a low risk level.

The reason for this is that, for example, in a situation where the mobile robot 100 travels straight forward, as the mobile robot 100 travels, the front area (a) is an area through which the mobile robot 100 passes, the lateral area (b) is a partially overlapping area, and the rear area (c) is an area that only becomes increasingly remote from the mobile robot 100 without overlapping. For example, in this manner, the safety area suitable for a direction in which an object approaches the mobile robot 100 can be marked by dividing the safety area into sub-areas by the travel direction of the mobile robot 100 and marking the sub-areas.

However, this division into the sub-areas can be changed in a manner that matches a change in the travel direction of the mobile robot 100. For example, in a situation where the mobile robot 100 rotates in place, a projection image can be projected in such a manner that the front area (a), the lateral area (b), and the rear area (c), which are described above, all have a high risk level.

The guide line 310, the safety guide 320, and the safety area 330, illustrated in FIGS. 3A to 3C, which are marked on the ground while the mobile robot 100 travels, as described in more detail below, can be changed based on at least one change in the travel state or the surrounding situation of the mobile robot 100.

In addition, while the mobile robot 100 projects the visual information for marking the safety area through the projector 160, or before or after the mobile robot 100 projects the visual information, the mobile robot 100 can control operations of other constituent elements, for example, a display unit 151, a sound output module 152, and the camera 121, to ensure the travel safety.

For example, while the mobile robot 100 projects the visual information, or before or after the mobile robot 100 projects the visual information, the mobile robot 100 can monitor the surrounding situation through the camera 121 and can output sound, text information, and the like for ensuring the safety, through the sound output module 152 and the display unit 151, respectively.

At this point, the visual information projected through the projector 160 can be varied in various ways to increase, maintain, or decrease a travel safety level based on the result of the monitoring by the camera 121. For example, the mobile robot 100 can control the operation of the projector 160 in such a manner that the visual information is projected in a manner that varies in size, shape, position, color, flickering effect, and the like.

As described above, the mobile robot 100 according to the embodiment of the present disclosure can project the visual information in various shapes for ensuring the travel safety, through the provided projector 160. Furthermore, the mobile robot 100 can vary the visual information, which is to be projected, in such a manner as to reflect the safety area that is changed according to the travel state and the surrounding situation of the mobile robot 100.

Practical examples where the visual information for marking the safety area is changed according to the travel speed of the mobile robot 100 are described in detail below.

Parts (a), (b), and (c) of FIG. 4 are views, respectively, that are referenced to describe a method of marking the safety area in a manner that varies with the travel speed of the mobile robot 100 according to an embodiment of the present disclosure.

First, in the embodiment of the present disclosure, the expression ‘while the mobile robot 100 travels’ implies that the mobile robot 100 travels at a low or high speed after starting to operate and that the mobile robot 100 comes to a stop after starting to operate.

In the practical examples described below, the term ‘first visual information’ for marking the access restriction area, which is projected onto the ground in the vicinity of the mobile robot 100, is used interchangeably with ‘safety area.’ Therefore, in a situation where the restriction of access to the mobile robot 100 needs to be stricter (or in a situation where the risk level is raised), the size of the safety area projected onto the ground in the vicinity of the mobile robot 100 can be increased. In contrast, in a situation where the restriction of access to the mobile robot 100 is flexible (or in a situation where the risk level is lowered), the size of the safety area projected onto the ground in the vicinity of the mobile robot 100 can be decreased or be maintained at the same as when the mobile robot 100 remains stationary. For example, a size of the safety area projected onto the ground in the vicinity of the mobile robot 100 can be dynamically changed (e.g., increased or decreased) based on a speed of the mobile robot 100.

In the stationary state of the mobile robot 100, only the minimum safety area should be sufficiently ensured. When the mobile robot 100 travels at a low speed, the safety area can be changed in such a manner as to be larger than the minimum safety area. In addition, when the mobile robot 100 travels at a high speed, the travel safety can be changed and enlarged by externally marking the maximum safety area. Ensuring the travel safety is conceptually similar to understanding a braking distance required of a traveling vehicle.

For example, the higher the travel speed of the mobile robot 100, the greater the braking distance required when a nearby object is sensed. This increases the likelihood of a collision with the nearby object. Therefore, in a situation where the mobile robot 100 travels at a high speed, the size of the safety area can be marked larger to ensure the travel safety. In contrast, in a situation where the mobile robot 100 travels at a low speed, the likelihood of a collision is low, and the braking distance is correspondingly short when an object is sensed. Thus, the size of the safety area can be sufficiently small.

The control unit 180 of the mobile robot 100 can control the operation of the projector 160 in such a manner that the safety area is changed, based on the travel speed of the mobile robot 100 sensed through the sensing unit 140.

The control unit 180 of the mobile robot 100 can compute the distance of the safety area based on the sensed travel speed and control the operation of the projector 160 based on the computed distance of the safety area in such a manner that the first visual information is changed. Specifically, the control unit 180 can control the projector 160 in such a manner that at least one of the following varies based on the distance of the safety area computed according to the travel speed of the mobile robot 100: the size, the position, or the shape of the access restriction area corresponding to the first visual information.

As illustrated in parts (a), (b), and (c) of FIG. 4, in a stationary state (a) of the mobile robot 100, a first access restriction area 410 determined in correspondence with a travel speed of ‘0’ is projected as the varied first visual information. In addition, in a low-speed state (b) that reflects the travel speed of the mobile robot 100, a second access restriction area 420 determined in correspondence with low-speed traveling is projected as the varied first visual information. Moreover, when the travel speed of the mobile robot 100 is in a high-speed state (c), a third access restriction area 430 determined in correspondence with high-speed traveling is projected as the varied first visual information.

The first, second and third access restriction areas 410, 420, and 430 have areas of different sizes. Specifically, the size of the first restriction area 410 is the smallest, and the size of the third restriction area 430 is the largest (e.g., size of 410<size of 420<size of 430).

In addition, the first, second and third restriction areas 410, 420, and 430 can be marked as different colored images. At this point, the colored images can be in different colors designated in such a manner to indicate the magnitude of the travel speed of the mobile robot 100. For example, the first access restriction area 410 matching the stationary state (a) can be green in color. In addition, for example, the second access restriction area 420 matching the low-speed state (b) can be yellow in color. In addition, for example, the third access restriction area 430 matching the high-speed state (c) can be red in color. In this manner, by applying a matched projection color that varies according to the travel speed of the mobile robot 100, it can be intuitively recognized from the outside whether or not the mobile robot 100 travels at a high speed.

As the travel speed of the mobile robot 100 is changed, the first visual information is projected after being changed in a manner that is adapted to any one of the first, second and third access restriction areas 410, 420, and 430.

In addition, according to a practical example, in a situation where the visual information is changed to reflect the transition from the second access restriction area 420 to the third access restriction area 430, an effect such as flickering can be added in such a manner that the change in the safety area is recognized from the outside. For example, in the above-mentioned color application example, the color of the second restriction area 420 is first turned red. Then, after the flickering effect applies to the second restriction area 420, the transition can take place from the second restriction area 420 to the third access restriction area 430. In addition, after the transition to the third access restriction area 430, a red-colored image can maintain the flickering effect for a predetermined time (e.g., 2 to 3 seconds), thereby alerting the surroundings of the mobile robot 100 to the likelihood of a collision.

A method of computing a distance D of the safety area that varies with the current travel speed of the mobile robot 100 is as follows.

This is a mathematical equation for computing the safety area for the mobile robot 100 by reflecting the current travel speed of the mobile robot 100. In the following mathematical equation (e.g., Equation 1 below), Vcurrent represents a current travel speed of the mobile robot 100, V_{low} represents a travel speed defined as a low-speed state, and V_{high} represents a travel speed defined as a high-speed state.

$$D = {D}_{low} + ( {D}_{high} - {D}_{low} ) * ( {V}_{current}^{2} - {V}_{low}^{2} ) / ( {V}_{high}^{2} - {V}_{low}^{2} ) \qquad [ Equation 1 ]$$

In addition, in the mathematical equation (Equation 1), D_{low} represents a distance of the safety area in the low-speed state, and D_{high} represents a distance of the safety area in the high-speed state. Specifically, D_{low} represents a protective deceleration area and a protective stop area that match a travel speed of 0.5 m/s or lower at a travel speed of 0.25 m/s or lower that varies according to a type of the provided proximity sensor 141. In addition, D_{high} represents a protective deceleration area and a protective stop area that match a travel speed of 0.95 m/s or higher.

When an obstacle is sensed through the proximity sensor 141, as one expected operation, the mobile robot 100 can reduce the current travel speed and then come to a stop. In this situation, a section where the mobile robot 100 reduces the travel speed can correspond to the protective deceleration area, and a section where the mobile robot 100 comes to a stop can correspond to the protective stop area.

The protective deceleration area and the protective stop area for the mobile robot 100 can vary according to the type of the provided proximity sensor 141 and the current travel speed of the mobile robot 100.

For example, the travel speed of the mobile robot 100 is sensed as follows, using a Lidar. When using the Lidar, for example, the low-speed state can represent 0.5 m/s or lower, and the high-speed state can represent 0.95 m/s or higher. In this situation, in the low-speed state, the protective deceleration area can represent 0.245 m to 0.745 m, and the protective stop area can represent 0.245 m or lower. In addition, in the high-speed state, the protective deceleration area represents 0.4 m to 1.25 m, and the protective stop area can represent 0.4 m or lower.

When using the Lidar, the distance D of the safety area that varies with the current travel speed is computed through the above mathematical expression. From this expression, it can be inferred that the distance D is changed in proportion to the square of the travel speed of the mobile robot 100.

In addition, for example, the travel speed of the mobile robot 100 is sensed as follows, using a TOF sensor. At this point, the TOF sensor serves as a front central sensor of the mobile robot 100. For example, it is assumed that the surrounding situation can be sensed within a range of 79 to 111 degrees. When using the TOF sensor, for example, the low-speed state can represent 0.25 m/s or lower, and the high-speed state can represent 0.95 m/s or higher. In this situation, in the low-speed state, the protective deceleration area represents 0.25 m to 0.75 m and the protective stop area can represent 0.25 m. In addition, in the high-speed state, the protective deceleration area represents 0.4 m to 1.25 m, and the protective stop area can represent 0.4 m or lower.

When using the TOF sensor, the distance D of the safety area that varies with the current travel speed is also computed through the above mathematical expression. From this expression, it can also be inferred that the distance D is changed in proportion to the square of the travel speed of the mobile robot 100.

In this manner, the first visual information, which indicates the distance D of the safety area that varies with the current travel speed, can be set to be equal to or greater than at least the protective deceleration area. Furthermore, the first visual information can be changed to have the same size as the protective stop area when the travel speed is reduced. Consequently, the first visual information is reduced in size.

According to a practical example, based on the current travel speed being sensed through the sensing unit 140 of the mobile robot 100, the control unit 180 can perceive the sensed travel speed as a change in the travel state of the mobile robot 100 and thus determine the change in the safety area. The control unit 180 can control the projector 160 in such a manner as to change at least one of the following: a color or a size of the first visual information projected according to this determination.

In addition, according to a practical example, an image size of the first visual image that is projected can increase or decrease in correspondence with the sensed travel speed. An image color of the first visual information can change in such a manner that a warning level varies in correspondence with the sensed travel speed.

As described above with reference to parts (a), (b), and (c) of FIG. 4, in a situation where the mobile robot 100 changes to the stationary state, the low-speed state, and then the high-speed state in this order, the image size of the first visual information gradually increases. When the sequence is reversed, the image size of the first visual information gradually decreases.

In addition, in a situation where, in parts (a), (b), and (c) of FIG. 4, the mobile robot 100 changes to the stationary state, the low-speed state, and then the high-speed state in this order, the color image of the first visual information can change in the direction of increasing the warning level (e.g., green->yellow->red). When the sequence is reversed, the color image of the first visual information can be changed in the direction of maintaining or decreasing the warning level.

Parts (a) and (b) of FIG. 5 and parts (a) and (b) of FIG. 6 are example views that are referenced to describe a method in which the mobile robot 100 according to embodiments of the present disclosure marks the safety area in a manner that varies according to the travel direction.

In the practical examples in parts (a), (b), and (c) of FIG. 4, the size and/or the color of the first visual information for marking the safety area that varies according to the travel speed of the mobile robot 100 is changed. Consequently, the mobile robot 100 operates in such a manner that the change in the travel state thereof can be recognized from the outside. In this situation, the distance D of the safety area is illustrated in such a manner as to be the same at any point from the center of the mobile robot 100.

The likelihood of a collision or the risk level within the safety area actually varies according to the current travel direction and or the travel technique of the mobile robot 100. For example, in a situation where the mobile robot 100 travels forward, in the safety area marked by the first visual information, the risk level is high in front of the mobile robot 100 and is low to the sides or behind the mobile robot 100. In addition, for example, in a situation where the mobile robot 100 travels in a circle, the risk level is high inward from the rotation direction and low outward from the rotation direction.

Accordingly, practical examples where the safety area is projected in a manner that varies in shape by applying the risk level that varies with the travel direction and the travel technique of the mobile robot 100 are described with reference to parts (a) and (b) of FIG. 5 and parts (a) and (b) of FIG. 6.

Specifically, part (a) of FIG. 5 illustrates that, in a situation (a) where the mobile robot 100 counterclockwise rotates, the first visual information is projected after changing the form of the safety area. Part (b) of FIG. 5 illustrates that, in a situation (b) where the mobile robot 100 clockwise rotates, the first visual information is projected after changing the form of the safety area.

In the situation (a) of FIG. 5 where the mobile robot 100 counterclockwise rotates, the risk level is raised in the area on the left side of the mobile robot 100, which is positioned inward in the counterclockwise direction. This is because the mobile robot 100 moves while changing the left-side direction of itself to the direction of progression. In contrast, while the mobile robot 100 counterclockwise rotates, the risk level is low in the area on the left side of the mobile robot 100 and is approximately the same as the risk level behind the mobile robot 100. Therefore, a first visual information 510, in which the left side of the safety area is reconfigured to be wide and elongated with respect to the front of the mobile robot 100, is projected (e.g., the first visual information 510 can have an oval shape that is elongated toward the left of the mobile robot 100).

In the situation (b), where the mobile robot 100 clockwise rotates, the risk level is raised in the area on the right side of the mobile robot 100, which is positioned inward in the clockwise direction. This is because the mobile robot 100 moves while changing the right-side direction of itself to the direction of progression. In contrast, while the mobile robot 100 counterclockwise rotates, the risk level is low in the area on the left side of the mobile robot 100 and is approximately the same as the risk level behind the mobile robot 100. Therefore, a first visual information 520, in which the right side of the safety area is reconfigured to be wide and elongated with respect to the front of the mobile robot 100, is projected (e.g., the first visual information 510 can have an oval shape that is elongated toward the right of the mobile robot 100).

According to a practical example, before the mobile robot 100 travels in a circle, the control unit 180 of the mobile robot 100, as illustrated in parts (a) and (b) of FIG. 5, can project a visual image (e.g., an arrow image in a rotational direction), which indicates a rotational direction, through the projector 160. Thus, a scheduled rotational direction can be pre-perceived from the outside.

Parts (a) and (b) of FIG. 6 each illustrate an example where, while the mobile robot 100 travels forward, the first visual information is projected after changing the form of the safety area according to the travel direction.

In a situation where, as in part (a) of FIG. 6, the mobile robot 100 travels forward with respect to the front of the mobile robot 100, the risk level is raised in the area in front of the mobile robot 100, which is positioned in the direction of progression. In contrast, as in part (b) of FIG. 6, the mobile robot 100 travels backward with respect to the front of the mobile robot 100, the risk level is raised in the area behind the mobile robot 100, which is positioned in the direction of progression.

In this situation, the control unit 180 of the mobile robot 100 can project the first visual information, in which a portion of the safety area that matches the travel direction of the mobile robot 100 is reconfigured to be wide and elongated.

For example, when the mobile robot 100, as part (a) of FIG. 6, travels forward, an image 610 of the safety area, in which the area in front of the mobile robot 100 is reconfigured to be wide and elongated, is projected onto the ground in the vicinity of the mobile robot 100 (e.g., a forward biased oval). In addition, for example, when the mobile robot 100, as part (b) of FIG. 6, travels backward, an image 620 of the safety area, in which the area behind the mobile robot 100 is reconfigured to be wide and elongated, is projected onto the ground in the vicinity of the mobile robot 100 (e.g., a rear biased oval).

In a practical example, through the sensing unit 140, the mobile robot 100 can sense the current travel direction of the mobile robot 100 or sense the surrounding situation to determine the change in the travel direction. The control unit 180 of the mobile robot 100 can control the projector 160 in such a manner that an image shape of the first visual information for marking the safety area is elongated toward the sensed travel direction while the mobile robot 100 travels.

The image form of the safety area, which changes with a change in the travel technique and the travel direction of the mobile robot 100, applies and varies in real time according to the sensed current travel direction. For example, as illustrated in parts (a) and (b) of FIG. 5 and parts (a) and (b) of FIG. 6, images 610 and 620 of the safety area that vary with the travel technique and the travel direction of the mobile robot 100 can be projected in a seamlessly varying manner while the mobile robot 100 travels. The safety area can be marked visually as if a shadow were formed in the vicinity of the mobile robot 100.

In a practical example, the length of the image form of the safety area, which is elongated toward the travel direction of the mobile robot, can be determined after reflecting the travel speed of the mobile robot 100.

For example, when the travel speed of the mobile robot 100 is in the high-speed state (c) of FIG. 4, a portion of the safety region, which is positioned toward the travel direction, can be reconfigured to be further elongated, and the resulting safety area can be marked. In addition, for example, when the travel speed of the mobile robot 100 is in the low-speed state (b) of FIG. 4, a portion of the safety area, which is positioned toward the travel direction, can be reconfigured to have a shorter length than in the high-speed state (c) of FIG. 4, and the resulting safety area can be marked. Accordingly, a feeling of the speed in the travel direction of the mobile robot 100 can be visually perceived by observing the image of the safety area, which is projected through the projector 160.

The objective of the image of the safety area, which is projected through the projector 160 of the mobile robot 100 is to ensure the travel safety. Therefore, while the mobile robot 100 travels, the marking of the safety area for ensuring the travel safety can be changed according to the sensed surrounding situation, for example, a state of a sensed obstacle, and the resulting safety area can be marked.

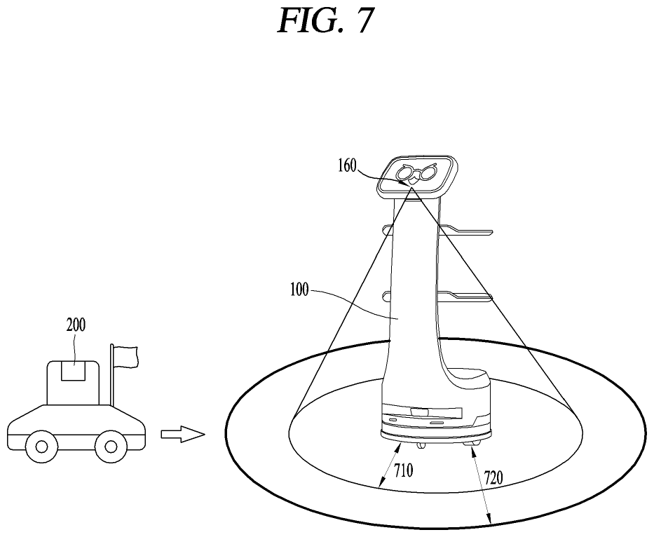

In this context, FIG. 7 is a view that is referenced to describe how the safety area is marked in a varied manner when an obstacle approaches the mobile robot 100 according to an embodiment of the present disclosure.

At this point, obstacles can include all types of objects that have a likelihood of collision while the mobile robot 100 travels within the travel space. However, in the present specification, a description is provided on the assumption of movable objects, such as a person, an animal, and another moving body, but embodiments are not limited thereto.

While traveling, the mobile robot 100 can sense a nearby obstacle through the sensing unit 140, for example, the proximity sensor 141 or the camera 121 and monitor the state of the sensed nearby obstacle. At this point, the expression ‘monitoring the state of the sensed nearby obstacle’ refers to monitoring the direction in which the sensed nearby obstacle moves toward or away from the mobile robot 100, information on the relative position of the nearby obstacle, and a gaze area in the situation of a person. In addition, in a practical example, the mobile robot 100 can also sense the relative position of another nearby robot by communicating with the nearby robot through the communication unit 110.

In this manner, when the presence or state of an obstacle to the mobile robot 100 is sensed, the control unit 180 can control the projector 160, based on the sensed obstacle approaching the mobile robot 100, in such a manner that the first visual information being projected varies according to the state of the sensed obstacle.

Specifically, in a situation where an obstacle approaches the mobile robot 100, the mobile robot 100 can project the first visual information after reconfiguring the first visual information in a manner that corresponds to the state of the sensed obstacle.

For example, when an obstacle approaches the mobile robot 100, the mobile robot 100 checks a gaze area of the obstacle through the camera 121. Then, the mobile robot 100 can change the position of the projection area or the color of the visual information in such a manner that the visual information is not directly projected within the field of view that includes the obstacle, and can project the resulting visual information.

In addition, for example, when an obstacle approaches the mobile robot 100, the mobile robot 100 can change the color or the size of the visual information in such a manner that the marking of the access restriction area is visually emphasized according to the moving state of the obstacle, and can project the resulting visual information.

In addition, for example, according to the type of obstacle approaching the mobile robot 100, the mobile robot 100 can change the color or the size of the visual information in such a manner as to guide a specific operation of the obstacle.

At this point, types of obstacles can include other robots that are unable to communicate with the mobile robot 100 and those that are initially able to communicate, but are currently unable to communicate due to communication failure or similar issues. In a situation where another robot is able to communicate with the mobile robot 100, it is possible for them to avoid a collision through mutual communication.

When a nearby obstacle is sensed, the mobile robot 100 can reduce the travel speed or avoid the nearby obstacle by traveling around the nearby obstacle. However, in a situation where it is impossible to travel around the nearby obstacle or where the braking distance increases although the travel speed is reduced, the access risk can be actively marked externally to ensure the travel safety, thereby guiding an operation for avoiding the risk.

For example, as illustrated in FIG. 7, it is assumed that the mobile robot 100 senses another robot 200 that approaches the mobile robot 100, while the mobile robot 100 projects the first visual image 710 for marking the safety area during traveling. Then, as one operation thereof, the mobile robot 100 can reduce the travel speed and then travel around an obstacle by monitoring a state (moving direction) of the robot 200.

In addition, as another operation thereof, the mobile robot 100 can project a second visual image 720, which expands the safety area toward a direction in which the robot 200 approaches the mobile robot 100. Thus, the robot 200 can visually perceive the second visual image 720 and be guided to avoid a collision. At this point, the second visual image 720 can be a predetermined color image or color pattern that is perceivable through a camera of the robot 200.

In this situation, when the projector 160 is also mounted to the robot 200, the robot 200 can project responsive visual information indicating that the second visual image 720 projected by the mobile robot 100 is perceived. Since the robot 200 travels around the mobile robot 100, the mobile robot 100 can continue traveling without concern about a collision instead of reducing the travel speed.

In this manner, the mobile robot 100 according to the embodiment of the present disclosure can ensure the safety area through the visual image projected through the projector 160 while the mobile robot 100 travels. Furthermore, the mobile robot 100 and the nearby robot 200 can recognize each other without communication between them. In addition, the mobile robot 100 and the robot 200 can perceive each other's next operation for the travel safety without communication between them.

Specifically, when the mobile robot 100 senses the nearby robot 200 through the sensing unit 140 or the camera 121 while traveling, the mobile robot 100 changes the visual image for ensuring safety, which is projected through the projector 160, into a designated color or pattern that can be recognized by the robot 200. At this point, in a situation where the robot 200 also includes a projector and marks a safety area for the robot 200, the mobile robot 100 can visually recognize an image projected by the robot 200, through the camera 121 and easily perceive a travel state (e.g., a travel direction and a travel speed) of the robot 200. The mobile robot 100 can determine the next operation based on the perceived travel state of the robot 200 and reflect the determined next operation in the visual image projected through the projector 160. At this point, the determined next operation can be one of the following: guiding the robot 200 to travel around the mobile robot 100 or having the mobile robot 100 travel around the robot 200. The robot 200 can perceive the next operation, determined by the mobile robot 100, through visual identification, and accordingly perform an operation of itself (e.g., traveling around the mobile robot 100 or traveling as planned without reducing speed).

In this manner, by using the visual image for marking the safety area, it is possible for the mobile robot 100 and the robot 200 to perceive each other in a situation where communication between them is not possible or even in an area where communication is impossible. Furthermore, the mobile robot 100 can alert the surroundings of the mobile robot 100 to the scheduled next operation. Accordingly, the mobile robot 100 can effectively deal with the robot 200 to prevent a collision or a similar accident, and a manager can visually anticipate the next operation of the mobile robot 100.

In addition, according to a practical example, when projecting the visual image for marking the safety area, the mobile robot 100 can reflect state information (e.g., an abnormal state, an insufficient remaining battery power, communication unavailability, or a similar condition) of itself, associated with the travel safety, in the visual image to be projected. For example, when an abnormal state of the mobile robot 100 is found, text or a symbol indicating the abnormal state can be added within the visual image to be projected. Accordingly, by checking the state of the mobile robot 100, the manager of the mobile robot 100 or a similar operator can intuitively determine whether the state of the mobile robot 100 is normal or abnormal.

The form of the mobile robot 100 according to the embodiment of the present disclosure can be changed and used in accordance with the intended purpose of the mobile robot 100.

For example, the shapes of a serving robot designed for serving customers and a guiding robot designed for guiding guests are predetermined. However, a product arrangement robot designed for storing, searching for, and moving products can be used with another moving body, for example, a cart being connected to the rear thereof. In this situation, the safety area for the mobile robot 100 whose form has been changed can also be changed.

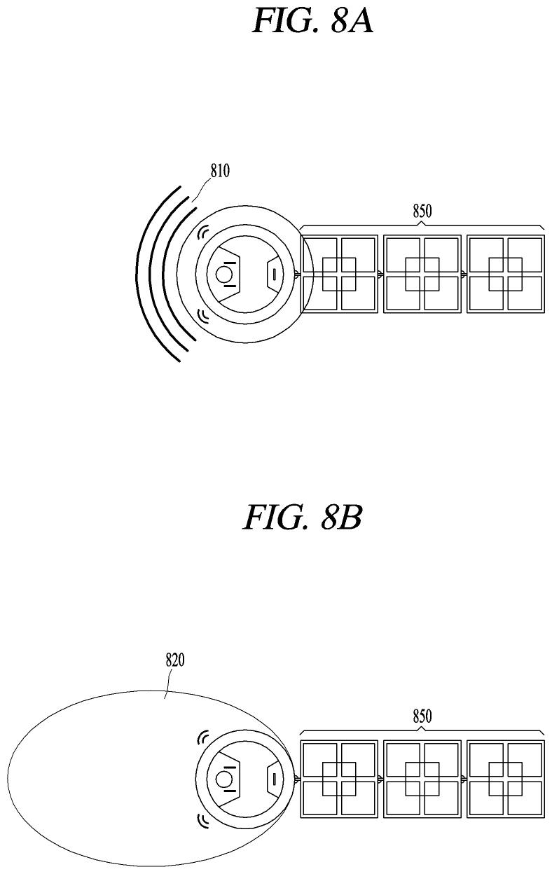

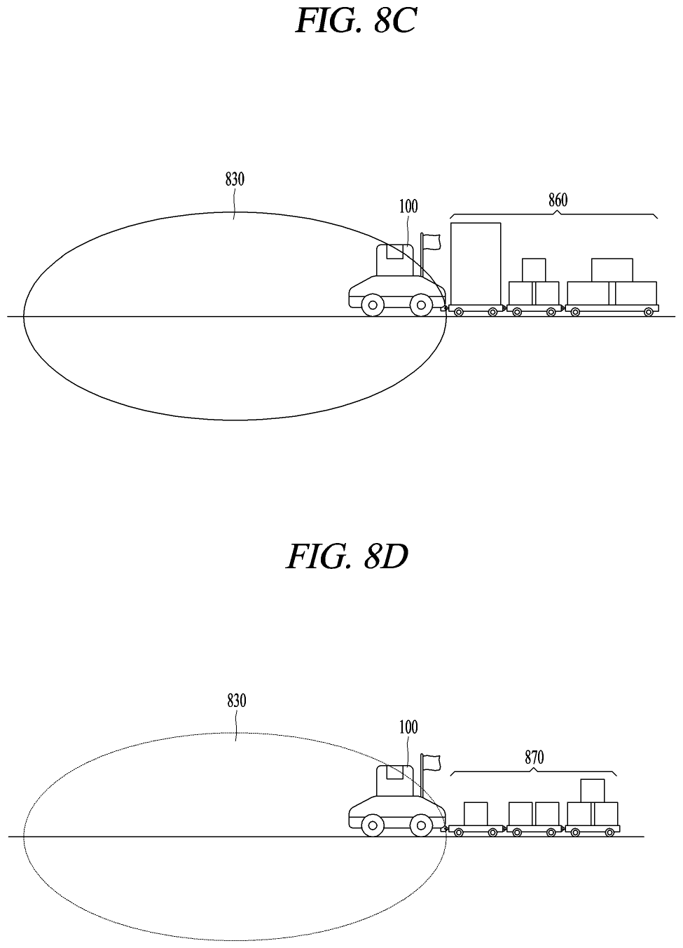

In this context, FIGS. 8A and 8B are example views, respectively, that are referenced to describe a change in the marking of the safety area, which varies with a change in the form of the mobile robot 100 according to an embodiment of the present disclosure.

As described above, in a situation where the mobile robot 100, like the product arrangement robot, is used with a cart or the like being connected to the rear thereof, the cart connected to the rear thereof can collide with the robot 200 or a person when the mobile robot 100 travels in a circle or changes the travel direction. The reason for this is that, when viewed from the front of the mobile robot 100, it is not possible to check whether or not a cart is connected to the rear of the mobile robot 100.

Accordingly, when a signal (‘connection signal’), indicating that a cart is connected to the rear of the mobile robot 100, is received through the sensing unit 140 or the input unit 120, the control unit 180 of the mobile robot 100 can control the projector 160 based on the received connection signal in such a manner as to change the visual image for marking the safety area.

At this point, changing the visual image to be projected based on the received connection signal means expanding the size of an area onto which the visual image is projected or changing the shape of the visual image to be projected. Consequently, by observing only the visual image projected onto the ground in front of the mobile robot 100, a moving object approaching from in front of the mobile robot 100 can easily ascertain whether or not a cart is used while connected to the rear of the mobile robot 100.

In addition, the connection signal indicating that a cart is connected to the rear of the mobile robot 100 can be generated by a sensing value from a sensor provided on the mobile robot 100 when the cart is connected thereto or be generated based on input from the manager or a similar operator.

In a situation where the cart is disconnected from the mobile robot 100, the control unit 180 of the mobile robot 100 can receive through the sensing unit 140 or the input unit 120 a signal (‘disconnection signal’) indicating that the cart is disconnected from the mobile robot 100. The control unit 180 can control the projector 160 based on the received disconnection signal in such a manner that the visual image for marking the safety area is restored to the original state thereof.

At this point, restoring the visual image to be projected to the original image thereof based on the received disconnection signal means restoring the size of an area onto which the visual image is projected to the original size thereof or restoring the shape of the visual image to the previous shape thereof.

In addition, the disconnection signal indicating that the cart is disconnected from the mobile robot 100 can be generated by the sensing value from the sensor provided on the mobile robot 100 or be generated based on input from the manager or a similar operator.

In this manner, in a situation where the usage or operational form of the mobile robot 100 according to the embodiment of the present disclosure is used or operates is changed by connecting a cart or the like to the mobile robot 100, the mobile robot 100 can recognize this change based on the received signal. Then, the mobile robot 100 can accordingly project the visual information after reflecting the change in the visual information for marking the safety.

According to a practical example, the control unit 180 of the mobile robot 100 can sense another moving body connected to a connection member of the mobile robot 100 based on the received signal and control the projector 160, based on information on the moving body, in such a manner that the first visual information is projected after being changed.

At this point, the connection member of the mobile robot 100 can be positioned on one side of the body of the mobile robot 100, for example, on the rear of the mobile robot 100 and be coupled to a connection member provided on the moving body (e.g., a cart). At this point, a sensor can be mounted to the connection member of the mobile robot 100 and generate a signal for sensing whether the moving body is connected or disconnected.

In addition, as another practical example, the control unit 180 (e.g., controller) of the mobile robot 100 can perceive the number of connected moving bodies, as information on the moving bodies connected to the mobile robot 100. The number of connected moving bodies can be perceived by receiving a signal corresponding to the presence of another moving body connected to each of the moving bodes through input from the manager or a similar operator or through a sensor or the like provided on each of the moving bodies. However, the control unit 180 of the mobile robot 100 can acquire information on the number of connected moving bodies through other methods that are not disclosed in the present disclosure.

When the information on the number of connected moving bodies is checked in this manner, the control unit 180 of the mobile robot 100 can change at least one of the following: the size or the shape of the visual image. The control unit 180 can then project the resulting visual image.

For example, when the number of moving bodies connected to the mobile robot 100 is great or increases, the size of each image can be expanded. In addition, for example, when the number of moving bodies connected to the mobile robot 100 is great, the visual image can be changed or text can be added in such a manner as to indicate the number of connected moving bodies (e.g., three curved lines 810 can be displayed on the ground corresponding to three connected moving bodes). The reason for this is that, in a situation where the moving body is connected to the rear of the mobile robot 100, the areas on the sides of the mobile robot 100 and the area behind the mobile robot 100 become risk areas that requires attention, unlike when the mobile robot 100 is used alone. For example, as more moving bodies are connected to the mobile robot 100, then the mobile robot 100 can increase the size of the projected image (e.g., oval 820).

In addition, in a practical example, the control unit 180 of the mobile robot 100 can control the projection by the projector 160 based on the information on the number of connected moving bodies in such a manner that the current travel speed and the travel direction of the mobile robot 100 are reflected in the visual image to be changed.

FIGS. 8A and 8B illustrate different examples, respectively, where, while the mobile robot 100 operates with three carts being connected to the rear thereof, the visual image for marking the safety area is projected onto the ground in front of the mobile robot 100 after being changed.

Specifically, FIG. 8A illustrates an example where as many guide lines 810, indicating access restriction, are projected onto the ground in front of the mobile robot 100 as there are moving bodies 850 connected to the rear of the mobile robot 100. In FIG. 8A, with the number of projected guide lines 810, a corresponding number of connected moving bodies (e.g., three connected moving bodies) can be reliably perceived from in front of the mobile robot 100.

As another example, FIG. 8B illustrates an example where as many visual images 820, expanded by expanding the size of the access restriction area, are projected onto the ground in front to the mobile robot 100 as there are the moving bodies 850 connected to the rear of the mobile robot 100. In FIG. 8B, the number of moving bodies 850 connected to the rear of the mobile robot 100 cannot be immediately identified from in front of the mobile robot 100, but a nearby object can exercise more caution based on the size of the expanded safety area.

In this manner, the mobile robot 100 can reflect not only the safety area, which varies according to the travel state of itself, but also caution, which must be taken by the connected moving body 850, in the visual image to be projected. Thus, the robot 200 that travels or the manager can pass through the travel space without concern about a collision with the moving body 850.

In a situation where the mobile robot 100 operates with the moving body 850 being connected thereto, the visual image for marking the safety area can be changed based on whether or not a load is present on the connected moving body 850 and/or based on an estimated amount of the load.

At this point, the load present on the connected moving body 850 and the estimated amount of the load can be sensed through a sensor included in each mobile body, for example, a load sensor and be transmitted to the mobile robot 100.

According to a practical example, the control unit 180 of the mobile robot 100 can expand the size of the visual image indicating the access restriction area or additionally change the shape thereof based on the load present on the moving body 850 connected to the mobile robot 100 or the amount of the load. For example, when the mobile robot 100 is towing or carrying a heavier load, then the size of the visual image indicating the access restriction area can be made larger in proportion to the load.

The reason for this is that, when the mobile robot 100 travels with a load being present on the moving body 850 connected to the mobile robot 100, there is a desire to externally mark the safety area in a further expanded manner considering the likelihood that the load present on the moving body 850 will fall off due to the travel state of the mobile robot 100.

In this context, FIGS. 8C and 8D are example views, respectively, that are referenced to describe a change in the marking of the safety area based on information on the amount of the load present on the moving body 850 connected to the mobile robot 100 according to embodiments of the present disclosure.

According to a practical example, the control unit 180 (e.g., controller) of the mobile robot 100 can receive information on the amount of the load present on each moving body 850 (e.g., a cart), as information on the connected moving body 580. At this point, the information on the amount of the load can be sensed through the load sensor provided on each moving body 850. Subsequently, the control unit 180 of the mobile robot 100 can estimate (or compute) the access restriction area around the entire modified mobile robot 100 based on the received information on the amount of the load and change at least one of the following: the size or the shape of the visual image to be projected, in such a manner as to mark the estimated access restriction area.

At this point, in a situation where a plurality of load sensors are provided on each moving body 850, a position at which the load is present can be ascertained.

For example, a load is present in a manner that is leaning to the left side, with the load sensors being provided on both lateral surfaces, respectively, of the moving body 850. In this situation, it can be determined through a difference between measurement values from the load sensors on both lateral surfaces that the load on the moving body 850 is present in a manner that is indeed leaning ‘to the left side.’

In this situation, while the mobile robot 100 travels, the visual image can be projected after expanding the size of the safety area for the travel safety. Alternatively, the visual image can be projected after changing the shape of the visual image in such a manner that a portion of the visual image, which corresponds to the left-side surface of the mobile robot 100, is further expanded.

For example, as illustrated in FIG. 8C, in a situation where various carts 860 having different shapes are connected to the rear of the mobile robot 100, loads present on the connected carts 860 can be sensed using at least two of the following: the sensing unit 140 and the communication unit 110 of the mobile robot 100, sensors provided on the connected carts 860, or inputs from the manager. Thus, an expanded safety area 830 can be projected.

In addition, for example, as illustrated in FIG. 8D, when the mobile robot 100 travels with different loads being present on carts 870, which have the same shape and are connected to the rear of the mobile robot 100, the mobile robot 100 can additionally change the shape of the expanded safety area 830 based on the amount of the load and the relative position of the load, and mark the resulting safety area 830.

In accordance with the purpose of using the mobile robot 100, the mobile robot 100 is used with the moving body 850 being connected to the rear of the mobile robot 100. In this situation, pieces of information such as the presence of the moving body 850, the number of connected moving bodies 850, and the loads present on the moving bodies are included in the visual image for the safety area, which is projected onto the ground in front of the mobile robot 100. Additionally, a safety distance is included in the visual image and is marked. Thus, the robot 200 or a person can pass around not only the mobile robot 100 that travels, but also the entire mobile robot 100 that includes various carts connected to the rear thereof.

The practical examples where the safety area is changed according to the travel state and the operational state of the mobile robot 100 are marked are described above. Practical examples are described in detail below, in which the travel safety is ensured by marking the safety area that is changed based on the spatial environment in which the mobile robot 100 travels.

At this point, the expression ‘based on the spatial environment in which the mobile robot 100 travels’ means ‘based on various types of environmental information perceived and/or collected based on the sensing value from the sensing unit 140 of the mobile robot 100 and/or the information received through the communication unit 110 thereof’.

At this point, for example, various types of environmental information can include various types of information, such as a state of the ground in the space, within which the mobile robot 100 travels, a travel space in one direction, a congested section, traffic information, a point that joins another travel path, a crossway, a travel-caution section including a corner or similar feature, a travel-risk section, and other relevant details.

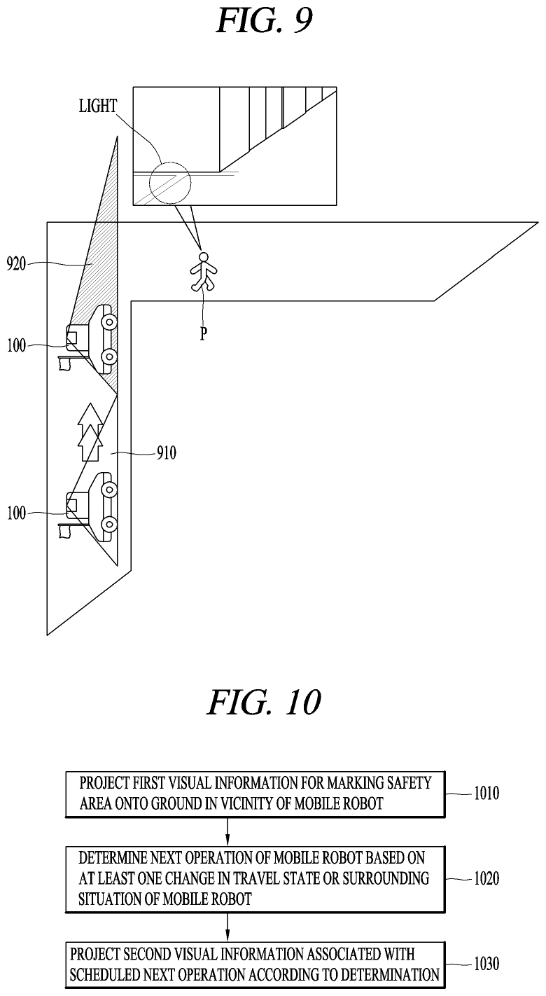

In this context, FIG. 9 is an example view that is referenced to describe how the safety area is marked in a varied manner when the mobile robot 100 travels along a corner.

The mobile robot 100 can recognize the position of itself and a wall state in the travel space through the sensing unit 140 while traveling within a designated travel space. However, in a situation where the mobile robot 100 approaches a corner, the mobile robot 100 can perceive this approaching, but a person or the robot 200 that approaches from the opposite direction of the corner cannot perceive the presence of the mobile robot 100. In this situation, the mobile robot 100 and a person or the robot 200 perceive each other when they reach a corner, raising concerns about collisions and accident risks.

Accordingly, the mobile robot 100 according to the embodiment of the present disclosure can reconfigure the visual image for the travel safety in an elongated manner before reaching a corner and can project the resulting visual image. Thus, the mobile robot 100 can control the projector 160 in such a manner that the projected visual image reaches the corner far earlier than the mobile robot 100.

Specifically, the mobile robot 100 can sense the surrounding situation of the mobile robot at the current position thereof through the sensing unit 140. The control unit 180 of the mobile robot 100 can perceive a crossway or a corner due to a sensed change in the surrounding situation. Subsequently, the control unit 180 controls the projector 160, based on the current position of the mobile robot 100 approaching a crossway or a corner, in such a manner as to change at least one of the following: the shape or the size of the first visual information.

At this point, the expression ‘the current position of the mobile robot 100 approaching a crossway or a corner’ can mean that the current position of the mobile robot 100 is positioned at a predetermined distance or more (e.g., 3 m or more) away from a point corresponding to a crossway or a corner and that the mobile robot 100 is scheduled to travel toward the point from the predetermined distance.

In addition, in a practical example, the control unit 180 of the mobile robot 100 can control the projector 160 in correspondence with the extent to which the mobile robot 100 approaches the crossway or the corner, in such a manner as to adjust the extent of at least one change in the shape or the size of the first visual image for marking the safety area. Subsequently, when it is sensed that the mobile robot 100 has passed through the crossway or the corner, the control unit 180 can control the projector 160 in such a manner that the shape or the size of the first visual image is restored to the previous state thereof.

Traveling around the corner, which is described above, includes traveling to enter the crossway. In a situation where the mobile robot 100 travels straight near the crossway, the mobile robot 100 itself does not travel around the corner; however, another robot has the likelihood of traveling around the corner. Therefore, in a situation where the mobile robot 100 travels to enter the crossway, the mobile robot 100 can perform an operation necessary to travel around the corner.

With reference to FIG. 9, while traveling, the mobile robot 100 projects the first visual image 910 for marking the safety area. While traveling, the mobile robot 100 can perceive a predetermined distance that the mobile robot 100 is required to travel to reach the corner, based on map data on the travel space or of the shape of the travel space sensed through the sensing unit 140. The mobile robot 100 can project the second visual image 920 at or beyond a predetermined distance before reaching the corner. The second visual image 920 results from varying the first visual image in such a manner as to be enlarged and elongated toward the corner in the direction of progression of the mobile robot 100. At this point, the closer the mobile robot 100 gets to the corner (or the higher the speed of the mobile robot 100), the more the second visual image 920 is elongated toward the corner.

Accordingly, a person P or the robot 200 approaching the corner can remotely take precautions by visually checking a luminescent portion (light) of the second visual image 920.

In a practical example, while projecting the second visual image 920, the closer the mobile robot 100 gets to the corner, the higher the alert level the mobile robot 100 can be raised. For example, as the mobile robot 100 approaches the corner, the mobile robot 100 can change the color of the second visual image 920 according to the raised alert level (for example, changing a color indicating a travel speed to red) and/or output warning sound through the sound output module 152. Alternatively, the mobile robot 100 can project the second visual image 920 with the flicking effect.

In this manner, each mobile robot 100 perceives a corner and projects the corner-varying visual image before reaching the corner. Thus, the likelihood of a collision can be reduced more reliably than when a sensor is installed on the wall at every corner. Furthermore, optimal travel safety can be ensured even in an environment where a layout is frequently changed such as in a warehouse.

After passing through the corner, the mobile robot 100 changes the second visual image 920 to the first visual image 910, which is an original state, and projects the resulting first visual image 910. At this point, according to the practical examples described above, the travel state and the operational state of the mobile robot 100 can be reflected in the first visual image 910.

In addition, an operation performed when the mobile robot 100 described above travels around a corner can be similarly applied even in a situation where the mobile robot 100 travels in the direction of approaching a point that joins another travel path, a crossway, another caution section, a travel-risk section, a doorway or a similar area.

While the mobile robot 100 travels within a one-way travel space, in a situation where the robot 200 attempts to enter the travel space from the opposite direction, the mobile robot 100 can perceive this attempt and additionally project the visual image indicating the direction of entering the travel space along with the safety area, thereby securing the travel safety.

As still another example, in a situation where the mobile robot 100 is about to enter a congested section, the mobile robot 100 can initially emphasize the visual image for marking the safety area, which is to be projected, in such a manner that the robot 200 or a person in the congested section perceives the intention of the mobile robot 100 to enter the congested section. Subsequently, the mobile robot 100 can reflect travel state information, indicating a reduction in the travel speed, in the visual image and project the resulting visual image.

As yet another example, in a situation where the mobile robot 100 senses that a state of the ground within the travel space is poor, the mobile robot 100 can project a warning image along with the visual image for marking the safety area, in such a manner that the robot 200 or a person in the vicinity of the mobile robot 100 takes caution at the affected area.

In this manner, the mobile robot 100 according to the embodiment of the present disclosure pre-perceives the environment of the space, within which the mobile robot 100 travels, reconfigures the visual image for securing the travel safety, and projects the resulting visual image. This process aids in remotely perceiving the presence of the mobile robot 100 even in the environment where the mobile robot 100 would otherwise be difficult to perceive. In addition, the caution section and the risk section that the mobile robot 100 senses while traveling can be externally marked in such a manner that the robot 200 or a person in the vicinity of the mobile robot 100 can perceive these sections, thereby aiding in securing the travel safety of the robot 200 or the safety of the person.

The mobile robot 100 according to the embodiment of the present disclosure may not only project, as the visual image, the current travel state or the operational state of itself and information on the current surrounding situation, but also externally pre-display the scheduled next operation to ensure the travel safety.

In this context, FIG. 10 is a flowchart that is referenced to describe another operational method of the mobile robot 100.

Unless otherwise specified, the operational method illustrated in FIG. 10 can be performed by the control unit 180 (e.g., controller or a processor) of the mobile robot 100. In addition, each step in the flowchart in FIG. 10 can be realized using a program command executed by at least one processor.

With reference to FIG. 10, while traveling, the mobile robot 100 can project the first visual information for marking the safety area through the projector 160 (e.g., step 1010).

At this point, the expression ‘while the mobile robot 100 travels’ includes: the mobile robot 100 traveling within a predetermined space; and the mobile robot 100 starting to operate but not yet moving or remaining stationary after completing a task. The reason for this is that, even in a state where the mobile robot 100 remains stationary, it is desirable to externally mark the safety area for a while to ensure the travel safety. This consideration accounts for a situation where mobile robot 100 waits to move by actually driving the travel unit 130 after starting to operate, or the likelihood of the mobile robot 100 moving within a predetermined time after completing a task.

To this end, the control unit 180 of the mobile robot 100 can project the first visual information for marking the safety area onto the ground before the mobile robot 100 starts to travel, and can control the projector 160, based on a predetermined time having elapsed after the mobile robot 100 stopped traveling, in such a manner as to interrupt the projection of the first visual information.

Next, the mobile robot 100 can determine the next operation of the mobile robot 100 based on at least one change in the travel state or the surrounding situation (e.g., step 1020).

At this point, the travel state of the mobile robot 100 can include at least one of the following: the travel direction of the mobile robot 100, the travel speed thereof, or the operational state thereof such as the use of a cart connected thereto. In addition, at this point, the surrounding situation of the mobile robot 100 can include environmental information (e.g., a state of the ground, corner entering, a caution section, a risk section, and the like) of the travel space, perceived and/or collected through the sensing unit 140 and/or the communication unit 110 of the mobile robot 100, and a position or a state of a moving object.

The control unit 180 of the mobile robot 100 can change one or more of the following: the size, the shape, or the color of the visual image for marking the safety area, or determine whether or not a highlighting effect applies, as in the practical examples described above, based on at least one change in the travel state or the surrounding situation. To this end, the various practical examples described above with reference to FIGS. 2 to 9 can apply.

In addition, the control unit 180 of the mobile robot 100 can determine the next operation that the mobile robot 100 intends to perform to ensure the travel safety. based on at least one change in the travel state or the surrounding situation. At this point, examples of the next operation can include both active operations, such as a traveling-around operation of the mobile robot 100, and passive operations, such as a change in the travel speed, an alert to the caution section, and an alert to the risk section.

Subsequently, the mobile robot 100 can project the second visual information associated with the scheduled next operation through the projector 160, based on the determination of the next operation (e.g., step 1030).

At this point, the second visual information does not mean the visual image that indicates the change in the safety area for the mobile robot 100 itself, which varies with changes in the travel state, the operational state, and the surrounding environment of the mobile robot 100, which are described above.

The second visual information means the projection image associated with the next operation of the mobile robot 100, which the mobile robot 100 determines to perform to ensure the travel safety in addition to changing the safety area. At this point, the projection image associated with the next operation is pre-projected, as a visual image that enables intuitive recognition of what is the determined next operation, through the projector 160 before the mobile robot 100 performs the next operation.

In this manner, the mobile robot 100 alerts in advance the surroundings of the mobile robot 100 to the next operation in addition to the safety area for itself. Thus, it is possible for the mobile robot 100 and the robot 200 or a person to perceive each other in an area or state where communication is impossible and/or in a situation where communication between them is not possible.

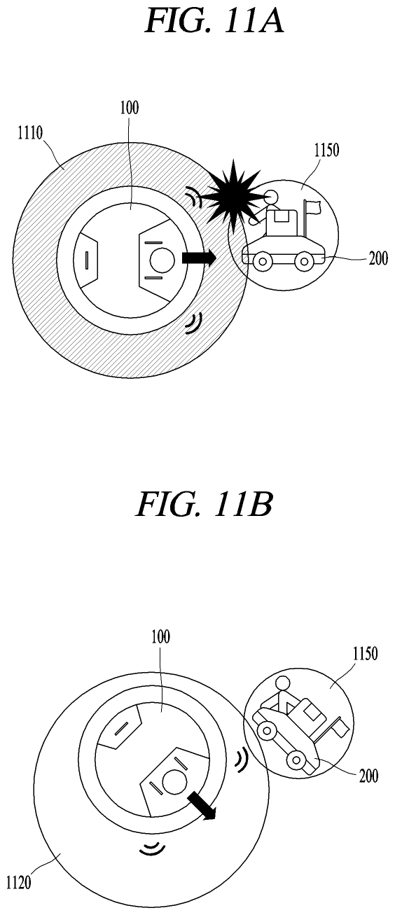

FIGS. 11A and 11B are example views each illustrating that, while traveling, the mobile robot 100 externally marks the intention thereof to perform the travel-around operation, along with the safety area for itself, in response to an approaching obstacle.

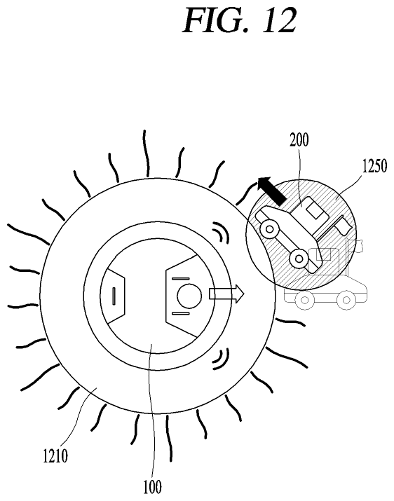

FIG. 12 is an example view illustrating that, while traveling, the mobile robot 100 externally marks the inability thereof to perform the travel-around operation, along with the safety area for itself, in response to an approaching obstacle.

Normally, when a nearby obstacle is sensed through the sensor, the mobile robot 100 can reduce the travel speed and then travel around the nearby obstacle or come to a stop to prevent a collision. However, the mobile robot 100 according to the present disclosure can preemptively alert the surroundings of the mobile robot 100 to the next operation of itself and guide the nearby obstacle to travel around the mobile robot 100 itself. As described above, this operation can be performed even in a situation where the mobile robot 100 cannot communicate with the robot 200.

In a practical example, in a situation where a nearby obstacle (e.g., the robot 200) approaches the mobile robot 100, the next operation of the mobile robot 100 can vary depending on whether or not the mobile robot 100 can travel around the nearby obstacle.

At this point, the expression “a situation where a nearby obstacle (e.g., the robot 200) approaches the mobile robot 100′ can refer to a situation where the robot 200 has entered the safety area marked by the mobile robot 100 or is attempting to enter the safety area. This situation can be distinguished from a usual situation where the mobile robot 100 senses the presence of a nearby obstacle through the sensing unit 140.

In addition, at this point, the feasibility of the travel-around operation can be determined by considering two situations: one where the travel-around operation is not possible due to the state of the mobile robot 100 or the characteristics of the travel space; and the other where the travel-around operation is determined not to be performed due to the priority of a task assigned to the mobile robot 100 or for securing the travel safety.

In either situation, the mobile robot 100 can mitigate concerns about collisions and reliably ensure the travel safety by alerting the surroundings of the mobile robot 100 to the next operation of itself, which is to be performed in response to an approaching obstacle. In addition, alerting the surroundings of the mobile robot 100 to the scheduled plan eliminates the need for both the mobile robot 100 and the robot 200 to perform the travel-around operation simultaneously, thereby enhancing travel efficiency, as well as securing the travel safety.

According to a practical example, before performing the scheduled next operation, the control unit 180 of the mobile robot 100 can control the projector 160 in such a manner as to project the second visual information indicating that a nearby obstacle is sensed.

At this point, the robot 200 visually perceives the second visual information through a camera or a similar device, and the manager observes the mobile robot 100 with his or her eyes. Thus, both the mobile robot 100 and the robot 200 can perceive that the presence of the mobile robot 100 itself has been sensed. In addition, the robot 200 can also output a signal indicating the intention of the robot 200 to perform the travel-around operation in response to the second visual information. In addition, in a situation where the robot 200 includes a projector, in response to the second visual information, the robot 200 can also operate in such a manner that the visual image indicating the intention of the robot 200 to perform the travel-around operation is projected onto the ground and that the mobile robot 100 visually perceives this intention through the camera 121.

In addition, according to a practical example, the control unit 180 of the mobile robot 100 can control the projector 160, based on the determination that the mobile robot 100 needs to travel around the nearby obstacle as the next operation of the mobile robot 100, in such a manner as to project the second visual information indicating the position of a nearby obstacle before performing the travel-around operation.

For example, the control unit 180 of the mobile robot 100 can project a visual image, similar to the visual image for marking the safety area for the mobile robot 100 itself, onto an area in the vicinity of the perceived obstacle. In this situation, the obstacle can perceive that the mobile robot 100 intends to travel around the obstacle and continue traveling. Accordingly, the inefficiency that occurs when both the mobile robot 100 and the obstacle simultaneously travel around each other is prevented, and the travel safety is more reliably ensured through mutual perception.

In addition, while projecting the second visual information indicating the position of a nearby obstacle, the control unit 180 of the mobile robot 100 can reduce the travel speed of the mobile robot 100 and reflect the reduced travel speed in marking the safety area before performing the travel-around operation as the scheduled next operation. At this point, the control unit 180 can indicate a reduction in the travel speed through a change in the color image in a state where the size of the safety area to be marked is maintained.

With reference to FIG. 11A, the mobile robot 100 changes a visual image 1110, based on the sensing of the robot 200 approaching the mobile robot 100, in such a manner that the safety area is emphatically marked, and projects the resulting visual image 1110.

In addition, the mobile robot 100 can project a guide image 1150 indicating the position of the robot 200 onto an area in the vicinity of the robot 200 in order to indicate that the robot 200 has been sensed. At this point, the projection of the guide image 1150 can be understood as indicating that the mobile robot 100 determined to perform the travel-around operation.

The robot 200 can perceive the mobile robot 100 by visually perceiving the emphasized visual image 1110. In addition, the robot 200 can perceive that the robot 200 itself does not need to perform the travel-around operation, by visually perceiving the guide image 1150 in the vicinity of the robot 200.

With reference to FIG. 11B, the mobile robot 100 reduces the travel speed to perform the travel-around operation and reflects the reduced travel speed in marking the safety area by changing a color image of the visual image 1110. For example, the visual image can change from the red-colored visual image 1110 available before reducing the travel speed to a yellow-colored visual image 1120 available after reducing the travel speed.

In FIG. 11B, while the mobile robot 100 changes the travel direction to perform the travel-around operation after reducing the travel speed, the guide image 1150 indicating the position of the robot 200 can also be projected continuously. In addition, while the mobile robot 100 changes the travel direction to perform the travel-around operation, the shape of the yellow-colored visual image 1120 can be changed after reflecting the changed travel direction.

Even in a situation where, after sensing an obstacle (e.g., the robot 200) that enters the safety area or attempts to enter the safety area, the mobile robot 100 determines not to perform the travel-around operation, it is necessary to change the marking of the safety area in such a manner that this determination is perceptible from the outside.

To this end, in a situation where the travel-around operation cannot be performed due to the travel state of the mobile robot 100 (this means that the travel-around operation is determined not to be performed), in order to allow the sensed nearby obstacle to move around the mobile robot 100, the control unit 180 of the mobile robot 100 can control the projector 160 in such a manner that third visual information indicating access restriction is projected onto the ground in the vicinity of the mobile robot 100.

At this point, the third visual information can be projected in a manner that overlaps with the first visual information for marking the safety area for the mobile robot 100. Alternatively, the third visual information, which includes a marking for guiding travel-around operation, can be projected onto the ground in the vicinity of the sensed obstacle.

For example, with reference to FIG. 12, the mobile robot 100 can project a visual image 1210, which indicates that the mobile robot 100 intends to maintain the current position and the traveling state of itself, in a manner that overlaps with the existing safety area. Concurrently or alternatively, the mobile robot 100 can project the visual image 1250 including directional information in such a manner that the sensed robot 200 performs the travel-around operation.

In this situation, the robot 200 in FIG. 12 can visually recognize the visual image 1210 and/or the visual image 1250, which are projected by the mobile robot 100, and perform a travel operation for collision avoidance. In addition, the mobile robot 100 can continuously travel without a collision with the robot 200 instead of reducing the travel speed or coming to a stop.

In this manner, regardless of the marking of the safety area for securing the travel safety, when the robot 200 or a person approaches the mobile robot 100, the mobile robot 100 according to the embodiment of the present disclosure can determine whether or not the travel-around operation is performed and externally project the scheduled next operation or travel plan through the projector 160. Accordingly, not only can the likelihood of a collision be prevented, but an efficient travel operation can also be achieved through mutual perception.

Practical examples are described in detail below, in which the mobile robot 100 senses a plurality of nearby obstacles and ensures the safety area for at least one of the plurality of obstacles.

It is desirable that each of the plurality of mobile robots that travel within a predetermined travel space includes a projector and externally marks the safety area therefor. However, if this is not the situation, the mobile robot 100 according to the embodiment of the present disclosure can instead alert the sensed robot 200 to the risk of a collision with a nearby person or another obstacle, which is caused by movement.

This alert aids in securing the travel safety within the entire travel space, especially in a situation where the robot 200 encounters the mobile robot 100, but does not sense another obstacle, or in a situation where the robot 200 travels in an abnormal state.

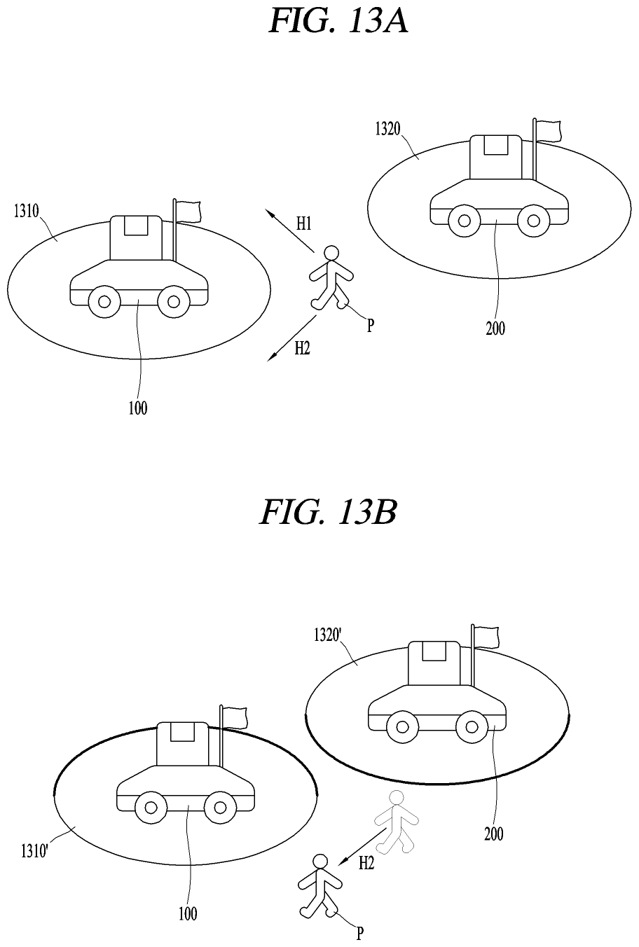

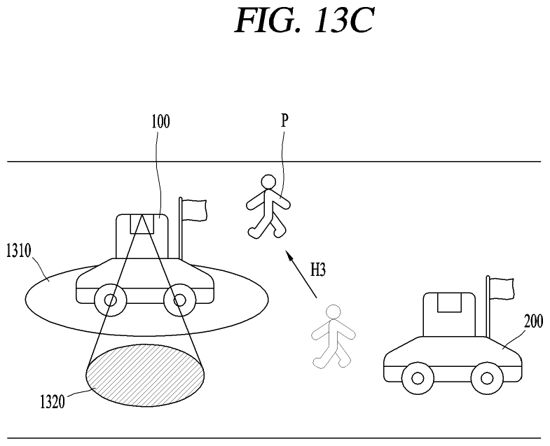

In this context, FIGS. 13A, 13B, and 13C are views, respectively, that are referenced to describe an example where, in a situation where the mobile robot 100 senses a plurality of nearby obstacles, the mobile robot 100 marks the safety area by considering expected movements of these obstacles.

According to a practical example, the mobile robot 100 can sense a plurality of obstacles present in the vicinity of the mobile robot 100 through the sensing unit 140. At this point, sensing a plurality of obstacles present in the vicinity of the mobile robot 100 means that a plurality of obstacles are positioned at a predetermined distance away from the safety area, but is sensed through the sensing unit 140, not that a plurality of obstacles have entered the safety area marked by the mobile robot 100.

The mobile robot 100 can determine an operation of providing a safety guide for one of the plurality of obstacles, as the next operation, based on the sensing of the plurality of nearby obstacles. The reason for this is that the plurality of obstacles are positioned outside the safety area marked by the mobile robot 100, and therefore, there is no need to perform the travel-around operation. In a situation where the relative positions of the plurality of obstacles are close to the mobile robot 100 or are predicted to be close to the mobile robot 100, the travel-around operation can be determined as the next operation.

Specifically, due to a change in the surrounding situation, the control unit 180 of the mobile robot 100 can determine to provide a mobile guide for a first obstacle as the next operation of the mobile robot 100, based on the sensing of the plurality of nearby obstacles through the sensing unit 140.

At this point, in a situation where the obstacle are a person and a robot, the first obstacle can refer to the person. In addition, in a situation where all the obstacles are the robots 200, the first obstacle can refer to the robot 200 that is close to the current position of the mobile robot 100.

The control unit 180 of the mobile robot 100 can control the projector 160, based on the determination to provide the mobile guide for the first obstacle, in such a manner as to project the visual information indicating the mobile guide, which is based on positions of the mobile robot 100 and a second obstacle other than the first obstacle.

At this point, the mobile guide for the first obstacle refers to a visual guide that can be projected to enable the first obstacle to move without colliding with the mobile robot 100 and the second obstacle. Therefore, the mobile guide for the first obstacle can also be referred to as a safety area for the first obstacle. In addition, the mobile guide for the first obstacle can be projected in a form suitable to mark the risk areas for the mobile robot 100 and the second obstacle.

Specifically, the visual information indicating the mobile guide for the first obstacle can be configured to include a first mobile guide and a second mobile guide. The first mobile guide indicates a ‘safety area,’ which is based on the positions of the mobile robot 100 and the second obstacle. The second mobile guide indicates a ‘risk area,’ which is based on the positions of the mobile robot 100 and the second obstacle. The second mobile guide is distinguished from the first mobile guide.

The first obstacle can safely move along the safety area included in the first mobile guide while avoiding the risk area included in the second mobile guide. Accordingly, the travel safety of the mobile robot 100 and the travel safety of the plurality of obstacles can be all ensured.

In a situation where the second obstacle is the robot 200, which is also a mobile robot including a projector, the mobile robot 100 and the robot 200 can mark at least one of the first and second mobile guides, which are described above, on the respective safety areas.

Specifically, with reference to FIG. 13A, it is assumed that the mobile robot 100 projects a safety area 1310 for itself through the projector 160 and that the robot 200 also projects a safety area 1320 for itself through the projector. At this point, in a situation where the person P, as the first obstacle, moves between the mobile robot 100 and the robot 200, a mobile guide for guiding the person P in moving safely can be determined to be projected.

The expected moving directions of the person P can be a first direction H1 and a second direction H2. With reference to FIG. 13B, the mobile robot 100 can project a safety area 1310′ that varies in such a manner as to include the second mobile guide for marking the risk area on the safety area. In addition, the robot 200 can also project a safety area 1320′ that varies in such a manner as to include the second mobile guide for marking the risk area for itself. At this point, the position of the second mobile guide is determined by considering the travel direction of each of the mobile robot 100 and the robot 200. In addition, the second mobile guide can be marked in such a manner as to be emphasized using a visually distinguishable color image.

Then, the person P can safely move in the second direction H2 after visually checking the varied safety areas 1310′ and 1320′. For example, half of the projected image on one side of the mobile robot 100 can be displayed differently than the other half of the projected image on one side of the mobile robot 100, in order to indicate that one side is safer than the other side, by varying the size, shape or color of the projected image (e.g., green vs red color, thin boarder vs. thick boarder, etc.). In this way, the person P can intuitively understand whether to walk to the left side or the right side of the mobile robot 100, in order to ensure his or her safety.

In a situation where the robot 200 does not include the projector and thus cannot mark the safety area for itself, the mobile robot 100 can alert the first obstacle to the risk area by instead marking the risk area based on the position of the robot 200.

For example, with reference to FIG. 13C, this alert occurs in a situation where there is a concern that the person P, who is the first obstacle sensed by the mobile robot 100, will collide with the robot 200 traveling behind the person P, which is the second obstacle and does not include the projector.

This situation is a situation where it is difficult for the person P to look back. Therefore, the mobile robot 100 can determine to mark the risk area instead of the robot 200 and accordingly project the risk area 1320 in such a manner as to correspond to the expected travel direction of the robot 200.

According to a practical example, in a situation where the mobile robot 100 assures through the visual recognition that there is no visual image projected by the robot 200, the mobile robot 100 can determine to project the risk area for the robot 200 instead of the robot 200. The person P can move in a third direction H3 to avoid the safety area 1310 and the risk area 1320 for the robot 200.

Another practical example is described below, in which the mobile robot 100 externally marks the risk section, encountered while traveling, to ensure the travel safety.

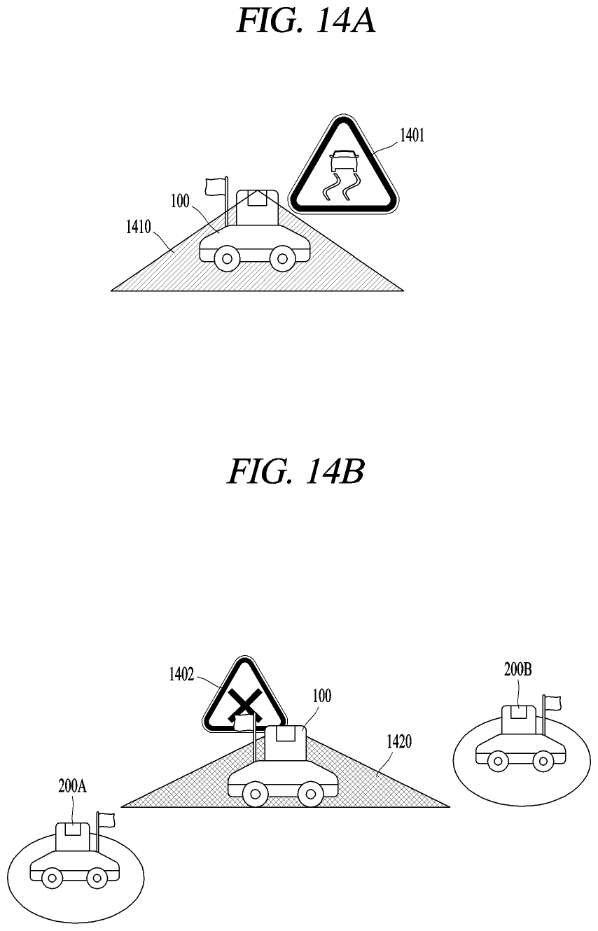

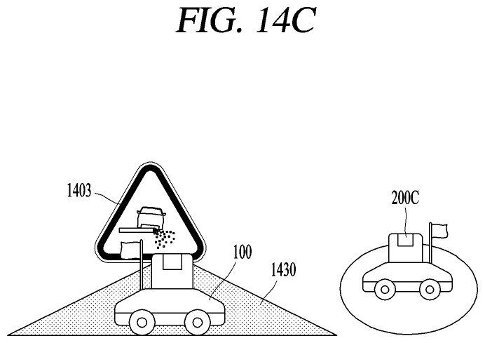

In this context, FIGS. 14A, 14B, and 14C are views each illustrating the risk area sensed while the mobile robot 100 travels according to embodiments of the present disclosure.

The mobile robot 100 can sense the state of the ground at a specific point or in a specific section through the sensing unit 140, for example, the ground sensor. The control unit 180 can determine the point or section in question as the risk area based on the sensed state of the ground.

In a situation where a task assigned to the mobile robot 100 has a high priority, the mobile robot 100 can transmit data on a travel map through the communication unit 110 and perform an update on the travel map. Otherwise, through the projector 160, the mobile robot 100 can project the visual image for marking the risk area for alerting the surroundings of the mobile robot to the point or section in question to ensure the travel safety.

To this end, the control unit 180 of the mobile robot 100 can detect the risk area based on the sensed state of the ground and control the projector 160 in such a manner as to project the second visual information indicating the detected risk area from before the mobile robot 100 comes to a stop as the determined next operation of the mobile robot 100.

At this point, the mobile robot 100 can indicate the visual information that varies according to the sensed cause of the risk.

For example, the mobile robot 100, as illustrated in FIG. 14A, can project a symbol 1401 indicating the cause or risk of sliding or a guide image 1410 including a colored pattern, onto the ground at the identified position. At this point, the guide image 100 can be projected in a different form (e.g., a triangle) in such a manner as to be distinguished from the safety area for the mobile robot 100.

In addition, for example, the mobile robot 100, as illustrated in FIG. 14B, can project a symbol 1402 indicating the risk of a ground cave-in or a guide image 1420 including a colored pattern, onto the ground at the identified position (e.g., indicating a spill or a hole in the ground or other obstacle). At this point, other nearby robots 200A and 200B mark safety areas for themselves, respectively. Consequently, the mobile robot 100 and the nearby robots 200A and 200B can sense one another, and the nearby robots 200A and 200B can travel around the guide image 1420. This travel-around operation is for traveling around the risk area and is distinguished from the travel-around operation for preventing a collision with the mobile robot 100.

In addition, for example, the mobile robot 100, as illustrated in FIG. 14C, can project a symbol 1403 indicating the risk of falling down a precipice or ledge or a guide image 1430 including a colored pattern, onto the ground at the identified position. In this situation, a nearby robot 200C can remotely identify the point in question through visual recognition and modify a travel plan to avoid the risk of falling down a precipice. In other words, the mobile robot 100 can project different types of information and warnings on the ground in order to warn other robots or pedestrians of different types of ground conditions and hazards.

Also, the visual images 1410, 1420, and 1430, which indicate the causes of the risks illustrated in FIGS. 14A, 14B and 14C, respectively, can be identified by the manager through visual monitoring. In addition, according to need, through mutual recognition with the robot 200, which has a projector function, the mobile robot 100 can also operate in such a manner as to alternately mark the risk area in a successive manner.

As described above, according to the embodiment of the present disclosure, while traveling, the mobile robot 100 marks the safety area through the projector 160. Furthermore, while traveling, the mobile robot adaptively varies the safety area according to the travel state and the surrounding situation of the mobile robot 100. Consequently, the travel safety can be ensured in a more reliable manner and can be quickly recognized from the outside. In addition, the visual information for ensuring the travel safety can be projected in various forms. The visual information to be projected can be flexibly varied in such a manner as to reflect the safety area that is changed according to the travel state and the surrounding situation of the mobile robot 100. In addition, mutual recognition is possible without direct communication between the mobile robot 100 and the robot 200 in the vicinity thereof, allowing them to recognize each other's next operations for the travel safety. Accordingly, the mobile robot 100 can effectively deal with the robot 200 to prevent a collision or a similar accident, and a manager can visually anticipate the next operation of the mobile robot 100. Moreover, in accordance with the purpose of using the mobile robot 100, the mobile robot 100 is used with the moving body 850 being connected to the rear of the mobile robot 100. In this situation, pieces of information such as the presence of the moving body 850, the number of connected moving bodies 850, and the loads present on the moving bodies 850 are included in the visual image for the safety area, which is projected onto the ground in front of the mobile robot 100. Additionally, the safety distance is included in the visual image and is marked. Thus, the robot 200 or a person can pass around not only the mobile robot 100 that travels, but also the entire mobile robot 100 that includes various carts connected to the rear thereof. In addition, the caution section and the risk section that the mobile robot 100 senses while traveling can be externally marked in such a manner that the robot 200 or a person in the vicinity of the mobile robot 100 can perceive these sections, thereby aiding in securing the travel safety of the robot 200 or the safety of the person.

Further scope of applicability of the present disclosure will become apparent from the detailed description. It should be understood, however, that the detailed description and specific examples, such as the preferred embodiment of the disclosure, are given by way of illustration only, since various changes and modifications within the spirit and scope of the disclosure will be apparent to those skilled in the art.

Features, structures, effects, and the like described in those embodiments are included in at least one embodiment of the present disclosure, and are not necessarily limited to only one embodiment. Furthermore, features, structures, effects, and the like illustrated in each embodiment can be combined or modified with respect to other embodiments by those skilled in the art to which the embodiments belong. Therefore, contents related to such combinations and modifications should be construed as being included in the scope of the present disclosure.

In addition, the foregoing description has been made with reference to the embodiments, but it is merely illustrative and is not intended to limit the present disclosure. It will be apparent that other changes and applications can be made by those skilled in the art to which the present disclosure belong without departing from substantial features of the embodiments of the present disclosure. For example, each component specifically shown in the embodiments can be modified and practiced. And it should be construed that differences relating to such changes and applications are included in the scope of the present disclosure defined in the appended claims.

What is claimed is:

1. A mobile robot comprising:
a projector configured to project visual information onto one or more surfaces; and
a controller configured to:
project, via the projector, first visual information for marking a safety area onto a ground surface in a vicinity of the mobile robot while the mobile robot is traveling, and
in response to determining a change in at least one of a traveling state of the mobile robot or a surrounding situation of the mobile robot, generate changed first visual information and project the changed first visual information onto the ground surface.

2. The mobile robot of claim 1, wherein the safety area is an access restriction area determined based on a form of the mobile robot and the traveling state of the mobile robot, and
wherein the first visual information includes at least one of an image or text that indicates the access restriction area in a manner that is visually distinguished from surroundings of the mobile robot.

3. The mobile robot of claim 1, further comprising:
a sensing unit configured to sense a speed of the mobile robot,
wherein the controller is further configured to:
in response to determining a change in the speed of the mobile robot, generate the changed first visual information based on changing at least one of a color of the first visual information or a size of the first visual information.

4. The mobile robot of claim 3, wherein the sensing unit is further configured to sense a travel direction of the mobile robot, and
wherein the controller is further configured to:
generate the changed first visual information based on elongating an image shape of the first visual information in a direction toward the travel direction.

5. The mobile robot of claim 3, wherein the controller is further configured to:
generate the changed first visual information based on increasing or decreasing an image size of the first visual information based on the speed of the mobile robot and changing a color of the first visual information based on the speed of the mobile robot.

6. The mobile robot of claim 1, further comprising:
a sensing unit configured to sense an obstacle in the vicinity of the mobile robot,
wherein the controller is further configured to:
generate the changed first visual information based on changing the first visual information according to a state of the obstacle.

7. The mobile robot of claim 1, wherein the traveling state includes an operational state that varies based on at least one other moving body being connected to the mobile robot, and
wherein the controller is further configured to:
in response to sensing that the at least one other moving body is connected to the mobile robot, generate the changed first visual information based on information about the at least one other moving body.

8. The mobile robot of claim 7, wherein the information about the at least one other moving body includes information on a number of moving bodies connected to the mobile robot, and
wherein the controller is further configured to:
generate the changed first visual information based on changing a size of the first visual information based on the information about the at least one other moving body or changing a shape of the first visual information based on the information about the at least one other moving body.

9. The mobile robot of claim 8, wherein the controller is further configured to:
project the changed first visual information onto the ground surface in a direction that corresponds to a traveling direction of the mobile robot.

10. The mobile robot of claim 7, wherein the information about the at least one other moving body includes information on an amount of load present on the at least one other moving body connected to the mobile robot, and
wherein the controller is further configured to:
determine an access restriction area based on the information on the amount of load present on the at least one other moving body, and
generate the changed first visual information by changing a size of the first visual information or a shape of the first visual information according to the access restriction area.

11. The mobile robot of claim 1, further comprising:
a sensing unit configured to sense the surrounding situation of the mobile robot at a position of the mobile robot,
wherein the controller is further configured to:
detect at least one of an upcoming crossway and an upcoming corner area based on the surrounding situation, and generate the changed first visual information by changing a size of the first visual information or a shape of the first visual information according to the at least one of the upcoming crossway and the upcoming corner area.

12. The mobile robot of claim 11, wherein the controller is further configured to:
adjust at least one of a size and a shape of the changed first visual information as the mobile robot approaches the at least one of the upcoming crossway and the upcoming corner area, and
in response to determining that the mobile robot has passed by the at least one of the upcoming crossway and the upcoming corner area, restore the at least one of the size and the shape of the changed first visual information to a previous state of the changed first visual information.

13. The mobile robot of claim 1, wherein the controller is further configured to:
project the first visual information onto the ground surface before the mobile robot starts to travel, and
in response to a predetermined amount of time elapsing after the mobile robot stops traveling, interrupt the projection of the first visual information.

14. A mobile robot comprising:
a projector configured to project visual information onto one or more surfaces; and
a controller configured to:
project, via the projector, first visual information for marking a safety area onto a ground surface in a vicinity of the mobile while the mobile robot is traveling, and
in response to determining a change in at least one of a traveling state of the mobile robot or a surrounding situation of the mobile robot, determine a next scheduled operation of the mobile robot, generate second visual information associated with the next scheduled operation and project the second visual information onto the ground surface.

15. The mobile robot of claim 14, further comprising:
a sensing unit configured to sense an obstacle in the vicinity of the mobile robot,
wherein the controller determines the next operation of the mobile robot based on the obstacle approaching the mobile robot and controls the projector to project the second visual information onto the ground surface before the next scheduled operation is performed by the mobile robot.

16. The mobile robot of claim 15, wherein the next scheduled operation includes the mobile robot traveling around the obstacle, and
wherein the second visual information indicates a position of the obstacle projected onto the ground surface before the mobile travels around the obstacle.

17. The mobile robot of claim 15, wherein the controller is further configured to:
in response to determining that mobile robot is unable to travel around the obstacle due to a condition, generate third visual information indicating access restriction and projecting the third visual information onto the ground surface.

18. The mobile robot of claim 14, further comprising:
a sensing unit configured to sense one or more obstacles in the vicinity of the mobile robot,
wherein the controller is further configured to:
in response to sensing a first obstacle and a second obstacle, generate the second visual information to include a mobile guide that indicates positions of the mobile robot and the second obstacle for guiding a traveling path of the first obstacle, and projecting the second visual information onto the ground surface.

19. The mobile robot of claim 18, wherein the second visual information marks a safety area based on the positions of the mobile robot and the second obstacle, and a risk area, based on the positions of the mobile robot and the second obstacle.

20. The mobile robot of claim 14, further comprising:
a sensing unit configured to sense a state of the ground surface while the mobile robot is traveling,
wherein the controller is further configured to:
determine a risk area based on the state of the ground surface, and project the second visual information on the ground surface to mark the risk area.

21. A mobile robot comprising:
a driver configured to move the mobile robot;
a projector configured to project visual information onto one or more surfaces; and
a controller configured to:
project, via the projector, first visual information onto a ground surface in a vicinity of the mobile while the mobile robot is traveling, and
in response to determining a change related to a condition of the mobile robot, adjusting an attribute of the first visual information or projecting second visual information onto the ground surface indicating a next scheduled operation of the mobile robot.

22. The mobile robot of claim 21, wherein the condition includes at least one of a speed of the mobile robot, a traveling state of the mobile robot, a surrounding situation of the mobile robot, and a current condition of the ground surface.

23. The mobile robot of claim 21, wherein the adjusting the attribute of the first visual information including varying a size, a shape, a pattern or a color of the first visual information.
